(19) United States
(12) Patent Application Publication
(10) Pub. No.: US 2021/0214549 A1
(43) Pub. Date: Jul. 15, 2021

(54) CURABLE EPOXY RESIN COMPOSITION AND LAMINATE USING THE SAME

(71) Applicant: KANEKA CORPORATION, Osaka (JP)

(72) Inventors: Ayumi Teragaki, Hyogo (JP); Toshihiko Okamoto, Hyogo (JP)

(73) Assignee: KANEKA CORPORATION, Osaka (JP)

(21) Appl. No.: 17/213,936

(22) Filed: Mar. 26, 2021

Related U.S. Application Data
(63) Continuation of application No. PCT/JP2019/037325, filed on Sep. 24, 2019.

(30) Foreign Application Priority Data
Sep. 27, 2018 (JP) 2018-182203

(51) Int. Cl. C08L 63/00; C09J 163/00; B32B 7/12

(52) U.S. Cl. CPC C08L 63/00; C09J 163/00; C08L 2205/025; C08L 2205/035; B32B 7/12

(57) ABSTRACT

The present disclosure relates to a curable epoxy resin composition comprising an epoxy resin (A), a toughening agent (B), and a carboxyl group-containing non-cross-linked acrylic resin (C). A ratio between initial lap shear strength (F1) measured in accordance with JIS K 6850 before the curable epoxy resin composition is left to stand in an environment of saturated water vapor at 40° C. and lap shear strength after moisture absorption test (F2) measured in accordance with JIS K 6850 after the curable epoxy resin composition is left to stand for 3 days in the environment of saturated water vapor at 40° C. is 0.5 or more. Also, the present disclosure relates to a laminate in which a plurality of substrates are joined via a cured product of the curable epoxy resin composition.

### TECHNICAL FIELD

One or more embodiments of the present invention relate to a curable epoxy resin composition that has excellent resistance to foaming by moisture absorption and can be favorably used as a structural adhesive, and a laminate using the curable epoxy resin composition.

### BACKGROUND

Epoxy resins have excellent adhesive strength, heat resistance, chemical resistance, and the like, and are thus widely used in vehicles such as automobiles. Moreover, epoxy resins have excellent electrical properties, and are thus also used in electricity-related fields and electronics fields. On the other hand, cured products of epoxy resins have low fracture toughness and may exhibit high brittleness, and therefore, curable epoxy resin compositions containing an epoxy resin and a toughening agent together are favorably used. For example, Patent Document 1 discloses a curable epoxy resin composition containing an epoxy resin and minute polymer particles serving as a toughening agent that each have a core-shell structure with a core layer made of diene-based rubber.

When a curable epoxy resin composition is used to bond a plurality of substrates to each other, the curable epoxy resin composition in an uncured state is applied to the substrates and then cured, and thus the plurality of substrates are joined to each other. In certain circumstances, a curable epoxy resin composition may be left in an uncured state for a long period of time after being applied to predetermined substrates. In such a case, there is a possibility that the uncured curable epoxy resin composition will absorb moisture while left uncured, and when it is heated and cured thereafter, the absorbed moisture evaporates at temperatures of 100° C. or higher, and thus voids are formed, resulting in a decrease in adhesive strength. Patent Document 2 proposes an epoxy-based adhesive containing an epoxy resin that is in the form of a liquid at room temperature, a modified epoxy resin, a gelling agent, and a water absorbing agent.

### PATENT DOCUMENTS

Patent Document 1: JP 2016-199673A
Patent Document 2: JP 2010-132732A

With the method disclosed in Patent Document 2, the adhesive strength of a cured product of an epoxy resin composition that has absorbed moisture is not sufficiently improved, and there is a demand for further improvement in the resistance to foaming by moisture absorption of an epoxy resin composition.

One or more embodiments of the present invention provide a curable epoxy resin composition having high resistance to foaming by moisture absorption, and a laminate using the curable epoxy resin composition.

### SUMMARY

One or more embodiments of the present invention relate to a curable epoxy resin composition comprising an epoxy resin (A), a toughening agent (B), and a carboxyl group-containing non-cross-linked acrylic resin (C).

In one or more embodiments of the present invention, it is preferable that a ratio (F2/F1) between initial lap shear strength (F1) measured in accordance with JIS K 6850 before the curable epoxy resin composition is left to stand in an environment of in saturated water vapor at 40° C. and lap shear strength after moisture absorption test (F2) measured in accordance with JIS K 6850 after the curable epoxy resin composition is left to stand for 3 days in the environment of in saturated water vapor at 40° C. is 0.5 or more.

In one or more embodiments of the present invention, it is preferable that a ratio (η100/η50) between a viscosity value (η50) of the curable epoxy resin composition at a shear speed of 5 s⁻¹ and 50° C. and a viscosity value (η100) of the curable epoxy resin composition at a shear speed of 5 s⁻¹ and 100° C. is 2.3 or more.

In one or more embodiments of the present invention, it is preferable that the toughening agent (B) is one or more selected from the group consisting of a polymer having a core-shell structure (B1), blocked isocyanate (B2), a rubber-modified epoxy resin (B3), a urethane-modified epoxy resin (B4), and a dimer acid-modified epoxy resin (B5).

In one or more embodiments of the present invention, it is preferable that the carboxyl group-containing non-cross-linked acrylic resin (C) has a weight average molecular weight of 50,000 or more and 10,000,000 or less.

In one or more embodiments of the present invention, it is preferable that the carboxyl group-containing non-cross-linked acrylic resin (C) has a glass-transition temperature of 50° C. or higher and 150° C. or lower.

In one or more embodiments of the present invention, it is preferable that the carboxyl group-containing non-cross-linked acrylic resin (C) contains methyl ethyl ketone soluble matter in an amount of 30 mass % or more and 100 mass % or less.

In one or more embodiments of the present invention, it is preferable that the carboxyl group-containing non-cross-linked acrylic resin (C) is a copolymer obtained by copolymerizing a monomer component including a carboxyl group and another monomer component.

In one or more embodiments of the present invention, it is preferable that the carboxyl group-containing non-cross-linked acrylic resin (C) contains a carboxyl group in an amount of 0.05 mmol/g or more and 5.0 mmol/g or less.

In one or more embodiments of the present invention, it is preferable that the epoxy resin (A) includes one or more selected from the group consisting of a bisphenol A-type epoxy resin and a bisphenol F-type epoxy resin that have an epoxy equivalent of less than 220 g/eq.

In one or more embodiments of the present invention, it is preferable that the curable epoxy resin composition contains the toughening agent (B) in an amount of 1 part by mass or more and 100 parts by mass or less, and the carboxyl group-containing non-cross-linked acrylic resin (C) in an amount of 2.5 parts by mass or more and 100 parts by mass or less, relative to 100 parts by mass of the epoxy resin (A).

In one or more embodiments of the present invention, it is preferable that the curable epoxy resin composition further contains an epoxy curing agent (D) in an amount of 1 part by mass or more and 80 parts by mass or less relative to 100 parts by mass of the epoxy resin (A).

In one or more embodiments of the present invention, it is preferable that the curable epoxy resin composition further contains a curing accelerator (E) in an amount of 0.1 part by mass or more and 10 parts by mass or less relative to 100 parts by mass of the epoxy resin (A).

In one or more embodiments of the present invention, it is preferable that the curable epoxy resin composition is a one-component curable epoxy resin composition.

Also, one or more embodiments of the present invention relate to a laminate, wherein a plurality of substrates are joined via a cured product of the curable epoxy resin composition.

With one or more embodiments of the present invention, it is possible to provide a curable epoxy resin composition having high resistance to foaming by moisture absorption, and a laminate using the curable epoxy resin composition.

### DETAILED DESCRIPTION OF THE EMBODIMENTS

The inventors of one or more embodiments of the present invention conducted numerous studies to improve the resistance to foaming by moisture absorption of a curable epoxy resin composition containing an epoxy resin and a toughening agent. As a result, they found that the resistance to foaming by moisture absorption of a curable epoxy resin composition can be improved by blending a carboxyl group-containing non-cross-linked acrylic resin with the curable epoxy resin composition containing an epoxy resin and a toughening agent. Specifically, compared with a curable epoxy resin composition that contains an epoxy resin and a toughening agent but does not contain a carboxyl group-containing non-cross-linked acrylic resin, and a curable epoxy resin composition that contains an epoxy resin, a toughening agent, and a cross-linked acrylic resin, which has been conventionally used as a gelling agent, the curable epoxy resin composition containing an epoxy resin, a toughening agent, and a carboxyl group-containing non-cross-linked acrylic resin has a higher ratio (F2/F1) of shear adhesive strength after moisture absorption to the shear adhesive strength before moisture absorption and has favorable resistance to foaming by moisture absorption. Also, compared with a curable epoxy resin composition containing an epoxy resin, a toughening agent, and a non-cross-linked acrylic resin having no carboxyl group, the curable epoxy resin composition containing an epoxy resin, a toughening agent, and a carboxyl group-containing non-cross-linked acrylic resin has a higher ratio (F2/F1) of the shear adhesive strength after moisture absorption to the shear adhesive strength before moisture absorption and has favorable resistance to foaming by moisture absorption.

The reason for the improvement in the resistance to foaming by moisture absorption of the curable epoxy resin composition containing an epoxy resin, a toughening agent, and a carboxyl group-containing non-cross-linked acrylic resin is presumed as follows. When a carboxyl group-containing non-cross-linked acrylic resin is blended with a curable epoxy resin composition containing an epoxy resin and a toughening agent, the epoxy resin and the carboxyl group-containing non-cross-linked acrylic resin are incompatible at temperatures lower than 100° C. (e.g., temperatures lower than or equal to 50° C.), but the carboxyl group-containing non-cross-linked acrylic resin is dissolved in the epoxy resin by being heated to temperatures higher than or equal to 100° C., and thus the viscosity of the curable epoxy resin composition is increased, thus making it possible to suppress foaming. That is, when a carboxyl group-containing non-cross-linked acrylic resin is used, the viscosity is slightly increased at temperatures lower than 100° C. (e.g., temperatures lower than or equal to 50° C.) compared with the case where a carboxyl group-containing non-cross-linked acrylic resin is not contained, whereas the viscosity is significantly increased at temperatures higher than or equal to 100° C. (temperatures at which water evaporates to form bubbles) compared with the case where a carboxyl group-containing non-cross-linked acrylic resin is not contained, thus making it possible to effectively suppress foaming caused by absorbed moisture during thermal curing, and resulting in an improvement in resistance to foaming by moisture absorption. On the other hand, when a non-cross-linked acrylic resin having no carboxyl group is used, the non-cross-linked acrylic resin having no carboxyl group is easily dissolved in an epoxy resin in both the case where the temperature is set to be lower than 100° C. (e.g., lower than or equal to 50° C.) and the case where the temperature is set to be higher than or equal to 100° C., and is thus less effective in increasing the viscosity when the temperature is increased, and therefore, foaming caused by absorbed moisture cannot be effectively suppressed during thermal curing. Moreover, when a cross-linked acrylic resin is used, an epoxy resin and the cross-linked acrylic resin are incompatible at temperatures lower than 100° C. (e.g., lower than or equal to 50° C.), and the cross-linked acrylic resin slightly swells at high temperatures higher than or equal to 100° C. and is insufficiently effective in increasing the viscosity, and therefore, foaming caused by absorbed moisture cannot be effectively suppressed during thermal curing. It should be noted that this presumption should not be construed as limiting the technical scope of one or more embodiments of the present invention.

Curable Epoxy Resin Composition

In one or more embodiments of the present invention, the curable epoxy resin composition contains an epoxy resin (A) (also referred to as an “Acomponent” hereinafter), a toughening agent (B) (also referred to as a “B component” hereinafter), and a carboxyl group-containing non-cross-linked acrylic resin (C) (also referred to as a “C component” hereinafter).

Epoxy Resin (A)

Various hard epoxy resins other than rubber-modified epoxy resins, urethane-modified epoxy resins, and dimer acid-modified epoxy resins, which will be described later, can be used as the epoxy resin (A). Examples thereof include, but are not limited to, a bisphenol A-type epoxy resin, a bisphenol F-type epoxy resin, a bisphenol AD-type epoxy resin, a bisphenol S-type epoxy resin, a glycidyl ester-type epoxy resin, a glycidyl amine-type epoxy resin, a novolak-type epoxy resin, a bisphenol A-propylene oxide adduct glycidyl ether-type epoxy resin, a hydrogenated bisphenol A-type epoxy resin, a hydrogenated bisphenol F-type epoxy resin, a flame-retardant epoxy resin such as a fluorinated epoxy resin and tetrabromobisphenol A glycidyl ether, a p-oxybenzoate glycidyl ether ester-type epoxy resin, an m-aminophenol-type epoxy resin, a diaminodiphenylmethane-based epoxy resin, various alicyclic epoxy resins, N,N-diglycidylaniline, N,N-diglycidyl-o-toluidine, triglycidylisocyanurate, divinylbenzenedioxide, resorcinol diglycidyl ether, polyalkylene glycol diglycidyl ether, glycol diglycidyl ether, diglycidyl ester of an aliphatic polybasic acid, glycidyl ether of a polyvalent aliphatic alcohol having a valency of two or more such as glycerin, an epoxydized product of an unsaturated polymer such as a chelate-modified epoxy resin, a hydantoin-type epoxy resin and petroleum resin, an amino-containing glycidyl ether resin, and epoxy compounds obtained by subjecting the epoxy resins to an addition reaction with bisphenol A, bisphenol F, or a polybasic acid, and commonly used epoxy resins can be used.

More specific examples of the polyalkylene glycol diglycidyl ether include polyethylene glycol diglycidyl ether and polypropylene glycol diglycidyl ether. More specific examples of the glycol diglycidyl ether include neopentyl glycol diglycidyl ether, 1,4-butanediol diglycidyl ether, 1,6-hexanediol diglycidyl ether, cyclohexanedimethanol diglycidyl ether. More specific examples of the diglycidyl ester of an aliphatic polybasic acid include adipate diglycidyl ester, sebacate diglycidyl ester, and maleate diglycidyl ester. More specific examples of the glycidyl ether of a polyvalent aliphatic alcohol having a valency of two or more include trimethylolpropane triglycidyl ether, trimethylolethane triglycidyl ether, castor oil-modified polyglycidyl ether, propoxylated glycerin triglycidyl ether, and sorbitol polyglycidyl ether. These epoxy resins may be used alone or in combination of two or more.

The polyalkylene glycol diglycidyl ether, the glycol diglycidyl ether, the diglycidyl ester of an aliphatic polybasic acid, and the glycidyl ether of a polyvalent aliphatic alcohol having a valency of two or more are epoxy resins having a relatively low viscosity and function as reactive diluents when used together with other epoxy resins such as a bisphenol A-type epoxy resin and a bisphenol F-type epoxy resin, and thus the balance between the viscosity of the composition and the physical properties of the cured product can be improved. Accordingly, in one or more embodiments of the present invention, it is preferable that the epoxy resin (A) includes one or two or more of these polyepoxides (reactive diluents). On the other hand, a monoepoxide functions as a reactive diluent as described later, but is not included in the epoxy resin (A). The amount of the reactive diluent (polyepoxide) may be 0.5 mass % or more and 20 mass % or less, 1 mass % or more and 10 mass % or less, or 2 mass % or more and 5 mass % or less, in 100 mass % of the epoxy resin (A).

In particular, the polyepoxide (reactive diluent) may be polyalkylene glycol diglycidyl ether and/or glycol diglycidyl ether, such as one or more selected from the group consisting of polyethylene glycol diglycidyl ether, polypropylene glycol diglycidyl ether, 1,4-butanediol diglycidyl ether, and 1,6-hexanediol diglycidyl ether, or such as one or more selected from the group consisting of polypropylene glycol diglycidyl ether and 1,6-hexanediol diglycidyl ether.

The chelate-modified epoxy resin is a reaction product produced by a reaction between an epoxy resin and a compound (chelating ligand) including a chelating functional group. When the chelate-modified epoxy resin is added to the curable epoxy resin composition of one or more embodiments of the present invention to be used as an adhesive for a vehicle, the curable epoxy resin composition has improved adhesion to a metal substrate surface polluted with an oily substance. Accordingly, in one or more embodiments of the present invention, it is preferable that the epoxy resin (A) contains the chelate-modified epoxy resin. The chelating functional group refers to a functional group included in a compound having a plurality of coordination positions that can be coordinated to metal ions, and examples thereof include phosphorus-containing acid groups (e.g., —PO(OH), a carboxylic acid group (—CO₂H), sulfur-containing acid groups (e.g., —SO₃H), an amino group, and a hydroxyl group (particularly hydroxyl groups adjacent to each other in an aromatic ring). Examples of the chelating ligand include ethylenediamine, bipyridine, ethylenediaminetetraacetic acid, phenanthroline, porphyrin, and crown ether. An example of commercially available chelate-modified epoxy resin is “Adekaresin EP-49-10N” manufacturedbyADEKA.

In 100 mass % of the epoxy resin (A), the amount of the chelate-modified epoxy resin that is used may be 0.1 mass % or more and 10 mass % or less, or 0.5 mass % or more and 3 mass % or less.

Among the above-described epoxy resins, those including at least two epoxy groups in one molecule are preferable because they are highly reactive and cured products thereof are likely to form a three-dimensional mesh when curing is performed.

Among the above-described epoxy resins, a bisphenol A-type epoxy resin and/or a bisphenol F-type epoxy resin are preferable because obtained cured products have high elastic moduli, have excellent heat resistance and adhesive properties, and are produced at relatively low cost, and a bisphenol A-type epoxy resin is particularly preferable.

Also, among the above-described various epoxy resins, those having an epoxy equivalent of less than 220 g/eq are preferable, those having an epoxy equivalent of 90 g/eq or more and 210 g/eq or less are more preferable, and those having an epoxy equivalent of 150 g/eq or more and 200 g/eq or less are even more preferable, from the viewpoint of the elastic moduli and heat resistance of obtained cured products. In particular, a bisphenol A-type epoxy resin and a bisphenol F-type epoxy resin that have an epoxy equivalent of less than 220 g/eq are preferable because they are in the form of a liquid at ordinary temperature (20° C.±5° C.) and a curable epoxy resin composition obtained therefrom has good handle ability. The term “in the form of a liquid at ordinary temperature” means that a substance has a softening point lower than ordinary temperature and exhibits fluidity at ordinary temperature. In one or more embodiments of the present invention, the epoxy equivalent of an epoxy resin is measured in accordance with JIS K 7236.

It is preferable to blend a bisphenol A-type epoxy resin and/or a bisphenol F-type epoxy resin having an epoxy equivalent of 220 g/eq or more and less than 5000 g/eq in a range of 40 mass % or less, or in a range of 20 mass % or less, in 100 mass % of the epoxy resin (A) because an obtained cured product has excellent impact resistance, but there is a risk that the viscosity of the composition will be increased and thus the workability will deteriorate.

Toughening Agent (B)

There is no particular limitation on the toughening agent (B) as long as it can improve the properties of a cured product of the curable epoxy resin composition, such as toughness, impact resistance, shear adhesion, and T-peel adhesion, and toughening agents that are commonly used as a toughening agent in a curable epoxy resin composition can be used as the toughening agent (B) as appropriate. In one or more embodiments of the present invention, the curable epoxy resin composition may contain the toughening agent (B) in an amount of 1 part by mass or more, 2 parts by mass or more, or 3 parts by mass or more, relative to 100 parts by mass of the epoxy resin (A), from the viewpoint of increasing the toughness of a cured product of the curable epoxy resin composition. Although there is no particular limitation on the upper limit of the amount of the toughening agent (B), the curable epoxy resin composition may contain the toughening agent (B) in an amount of 100 parts by mass or less, 70 parts by mass or less, or 50 parts by mass or less, relative to 100 parts by mass of the epoxy resin (A), from the viewpoint of the handleability of the curable epoxy resin composition.

From the viewpoint of further improving the properties of a cured product of the curable epoxy resin composition, such as toughness, impact resistance, shear adhesion, and T-peel adhesion, the toughening agent (B) may be one or more selected from the group consisting of a polymer having a core-shell structure (B1), blocked isocyanate (B2), a rubber-modified epoxy resin (B3), a urethane-modified epoxy resin (B4), and a dimer acid-modified epoxy resin (B5), or may include one or more selected from a polymer having a core-shell structure (B1) and blocked isocyanate (B2), or may include a polymer having a core-shell structure (B).

Polymer Having a Core-Shell Structure (B1)

The polymer having a core-shell structure (B1) is a polymer having a core-shell structure including a core layer and a shell layer that covers the core layer.

Although there is no particular limitation on the polymer having a core-shell structure (B1), it may have a volume average particle diameter (Mv) of 10 nm or more and 2000 nm or less, 30 nm or more and 600 nm or less, 50 nm or more and 400 nm or less, 50 nm or more and 300 nm or less, or 100 nm or more and 200 nm or less, in consideration of industrial productivity. It should be noted that the volume average particle diameter (Mv) of the polymer having a core-shell structure (B1) can be measured using Microtrac UPA150 (manufactured by Nikkiso Co., Ltd.).

In the curable epoxy resin composition, it is preferable that the half width of the number distribution of the particle diameters of the polymer having a core-shell structure (B1) is 0.5 or more times as large as the number average particle diameter and smaller than or equal to the number average particle diameter. In this case, the curable epoxy resin composition has low viscosity at ordinary temperature and is thus easy to handle. The number distribution of the particle diameters of the polymer having a core-shell structure (B1) may include two or more maximum values from the viewpoint of easily realizing such a specific particle diameter distribution, or may have two or more and three or less maximum values from the viewpoint of manufacturing time and cost, or may have two maximum values. In particular, it is preferable that a polymer having a core-shell structure (B1) with a volume average particle diameter of 10 nm or more and less than 150 nm in an amount of 10 mass % or more and 90 mass % or less and a polymer having a core-shell structure (B1) with a volume average particle diameter of 150 nm or more and 2000 nm or less in an amount of 10 mass % or more and 90 mass % or less are contained.

It is preferable that the polymer having a core-shell structure (B1) disperses as primary particles in the curable epoxy resin composition. The term “the polymer having a core-shell structure (B1) disperses as primary particles in the curable epoxy resin composition” (also referred to as a “first-order dispersion” hereinafter) means that the particles of the polymer having a core-shell structure (B1) disperse in the curable epoxy resin composition in the state in which they are substantially independent of (not in contact with) one another, and the dispersion state can be confirmed by dissolving a portion of the curable epoxy resin composition in a solvent such as methyl ethyl ketone and measuring the particle diameters using a laser light scattering particle diameter measurement apparatus or the like, for example.

The value of the volume average particle diameter (Mv)/the number average particle diameter (Mn) of the polymer having a core-shell structure (B1) determined through the above-described particle diameter measurement is not particularly limited, but may be 3 or less, 2.5 or less, 2 or less, or 1.5 or less. When the volume average particle diameter (Mv)/the number average particle diameter (Mn) is 3 or less, it is considered that the particles are favorably dispersed. On the contrary, when the volume average particle diameter (Mv)/number average particle diameter (Mn) is more than 3 in the particle size distribution of a curable epoxy resin composition, the physical properties such as impact resistance and adhesion of an obtained cured product may be low.

The volume average particle diameter (Mv)/the number average particle diameter (Mn) of the polymer having a core-shell structure (B1) can be determined by measuring My and Mn using Microtrac UPA (manufactured by Nikkiso Co., Ltd.) and dividing My by Mn.

“Stable dispersion” of the particles of the polymer having a core-shell structure (B1) means a state in which the particles of the polymer having a core-shell structure (B1) steadily disperse in a successive layer under normal conditions for a long period of time without aggregation, separation, and precipitation, and it is preferable that the distribution of the particles of the polymer having a core-shell structure (B1) in the successive layer does not substantially change, and the “stable dispersion” can be maintained even when the curable epoxy resin composition is stirred in the state in which its viscosity is increased due to heating.

Although there is no particular limitation on the structure of the polymer having a core-shell structure (B1), it is preferable that the polymer having a core-shell structure (B1) has a core-shell structure with two or more layers including a core layer and a shelllayer. Also, the polymer having a core-shell structure (B1) can be configured to have a structure with three or more layers including an intermediate layer that covers the core layer and a shell layer that covers the intermediate layer.

Hereinafter, the layers of the polymer having a core-shell structure (B1) will be described in detail.

Core Layer

It is preferable that the core layer is an elastic core layer having rubber-like properties in order to improve the toughness of a cured product of the curable epoxy resin composition. To achieve the rubber-like properties, the gel content of the elastic core layer may be 60 mass % or more, 80 mass % or more, 90 mass % or more, or 95 mass % or more. It should be noted that the term “gel content” as used herein means a ratio of the amount of toluene insoluble matter to the total amount of toluene insoluble matter and toluene soluble matter that are separated after 0.5 g of the polymer having a core-shell structure (B1) obtained through solidification and drying is immersed in 100 g of toluene and left to stand at 23° C. for 24 hours.

It is preferable that the elastic core layer is constituted by a rubber component. When the polymer having a core-shell structure (B1) whose core layer is constituted by a rubber component is used as the toughening agent (B), a cured product having excellent toughness and impact peel-resistant adhesion is obtained. The elastic core layer may be constituted by one or more rubber components selected from the group consisting of diene-based rubber, (meth)acrylate-based rubber and organosiloxane-based rubber, and may be constituted by diene-based rubber. When the core layer is constituted by diene-based rubber, the impact peel-resistant adhesion of a cured product thereof is further improved.

Examples of a conjugated diene-based monomer (also referred to as a “first monomer” hereinafter) included in the diene-based rubber include 1,3-butadiene, isoprene, 2-chloro-1,3-butadiene, and 2-methyl-1,3-butadiene. These conjugated diene-based monomers may be used alone or in combination of two or more.

The core layer may contain the conjugate diene-based monomer in an amount in a range of 50 mass % or more to 100 mass % or less, in a range of 70 mass % or more to 100 mass % or less, or in a range of 90 mass % or more to 100 mass % or less. When the content of the conjugated diene-based monomer is 50 mass % or more, the impact peel-resistant adhesion of a cured product of the curable epoxy resin composition is likely to be improved.

Examples of the (meth)acryl-based monomer (also referred to as a “first monomer” hereinafter) included in the (meth)acryl-based rubber to be used for the elastic core layer include, but are not particularly limited to, alkyl (meth)acrylates such as methyl (meth)acrylate, ethyl (meth)acrylate, butyl (meth)acrylate, 2-ethylhexyl (meth)acrylate, octyl (meth)acrylate, dodecyl (meth)acrylate, stearyl (meth)acrylate, and behenyl (meth)acrylate; aromatic ring-containing (meth)acrylates such as phenoxyethyl (meth)acrylate and benzyl (meth)acrylate; hydroxyalkyl (meth)acrylates such as 2-hydroxyethyl (meth)acrylate and 4-hydroxybutyl (meth)acrylate; glycidyl (meth)acrylates such as glycidyl (meth)acrylate and glycidylalkyl (meth)acrylates; alkoxyalkyl (meth)acrylates: allylalkyl (meth)acrylates such as allyl (meth)acrylate and allylalkyl (meth)acrylates; and polyfunctional (meth)acrylates such as monoethylene glycol di(meth)acrylate, triethylene glycol di(meth)acrylate, and tetraethylene glycol di(meth)acrylate. These (meth)acrylate-based monomers may be used alone or in combination of two or more. One or more selected from the group consisting of ethyl (meth)acrylate, butyl (meth)acrylate, and 2-ethylhexyl (meth)acrylate are particularly preferable. In one or more embodiments of the present invention, the term “(meth)acrylate” means acrylate and/or methacrylate.

Examples of a vinyl-based monomer (also referred to as a “second monomer” hereinafter) that can be copolymerized with the first monomer (conjugated diene-based monomer or (meth)acrylate-based monomer) include vinyl arenes such as styrene, α-methylstyrene, monochlorostyrene, and dichlorostyrene; vinyl carboxylic acids such as acrylic acid and methacrylic acid; vinyl cyans such as acrylonitrile and methacrylonitrile; vinyl halides such as vinyl chloride, vinyl bromide, and chloroprene; vinyl acetate; alkenes such as ethylene, propylene, butylene, and isobutylene; and polyfunctional monomers such as diallyl phthalate, triallyl cyanurate, triallyl isocyanurate, and divinyl benzene. These vinyl-based monomers may be used alone or in combination of two or more. Styrene is particularly preferable.

The core layer may contain the vinyl-based monomer that can be copolymerized with the conjugated diene-based monomer in an amount in a range of 0 mass % or more to 50 mass % or less, in a range of 0 mass % or more to 30 mass % or less, or in a range of 0 mass % or more to 10 mass % or less. When the content of the vinyl-based monomer that can be copolymerized with the conjugated diene-based monomer is 50 mass % or less, the impact peel-resistant adhesion of a cured product of the curable epoxy resin composition is likely to be improved.

The diene-based rubber may be butadiene rubber in which 1,3-butadiene is used and/or butadiene-styrene rubber, which is a copolymer of 1,3-butadiene and styrene, or butadiene rubber, because they have a high toughness improving effect and an impact peel-resistant adhesion improving effect, and they have a low affinity for an epoxy resin serving as a matrix resin and thus an increase in viscosity thereof over time due to the swelling of the core layer is less likely to occur.

In one or more embodiments of the present invention, the glass-transition temperature (also referred to merely as “Tg” hereinafter) of the core layer may be 0° C. or lower, −20° C. or lower, −40° C. or lower, or −60° C. or lower, from the viewpoint of improving the toughness of a cured product of the curable epoxy resin composition.

Moreover, the volume average particle diameter of a core layer polymer constituting the core layer may be 30 nm or more and 2000 nm or less, or 50 nm or more and 1000 nm or less. When the volume average particle diameter is 10 nm or more, the core layer polymer can be stably obtained, and when the volume average particle diameter is 2000 nm or less, a final structure is likely to have improved heat resistance and impact resistance. It should be noted that, in one or more embodiments of the present invention, the volume average particle diameter of the core layer polymer constituting the core layer can be measured using Microtrac UPA150 (manufactured by Nikkiso Co., Ltd.).

The amount of the core layer (the core layer polymer constituting the core layer) may be 40 mass % or more and 97 mass % or less, 60 mass % or more and 95 mass % or less, 70 mass % or more and 93 mass % or less, or 80 mass % or more and 90 mass % or less, when the amount of the polymer having a core-shell structure (B1) is taken as 100 mass %. If the amount of the core layer is less than 40 mass %, the effect of improving the toughness of a cured product may be impaired. If the amount of the core layer is greater than 97 mass %, the minute particles of the polymer having a core-shell structure (B1 are likely to aggregate, and thus the curable epoxy resin composition may have high viscosity and be hard to handle at ordinary temperature.

In one or more embodiments of the present invention, the core layer has a single-layer structure in many cases, but may also have a multilayer structure including two or more layers with rubber elasticity. When the core layer has a multilayer structure, the layers thereof may have different polymer compositions within the scope as disclosed above.

Intermediate Layer

In one or more embodiments of the present invention, an intermediate layer may be formed as needed. Specifically, a cross-linked rubber surface layer, which will be described below, may be formed as the intermediate layer. From the viewpoint of the effect of improving the toughness of a cured product of the curable epoxy resin composition and the effect of improving the impact peel-resistant adhesion thereof, it is preferable that an intermediate layer, particularly a cross-linked rubber surface layer below, is not contained.

When the intermediate layer is included, a ratio of the amount of the intermediate layer (intermediate layer polymer) to 100 parts by mass of the core layer (core layer polymer) may be 0.1 part by mass or more and 30 parts by mass or less, 0.2 part by mass or more and 20 parts by mass or less, 0.5 part by mass or more and 10 parts by mass or less, or 1 part by mass or more and 5 parts by mass or less.

The cross-linked rubber surface layer can be made of an intermediate layer polymer obtained by polymerizing a cross-linked rubber surface layer component containing a polyfunctional monomer having two or more radical polymerizable double bonds in one molecule in an amount of 30 mass % or more and 100 mass % or less and another vinyl monomer in an amount of0 mass % or more and 70 mass % or less. When the cross-linked rubber surface layer having the configuration described above is formed, an effect of reducing the viscosity of the curable epoxy resin composition and an effect of improving the dispersibility of the polymer having a core-shell structure (B1) in the epoxy resin (A) can be imparted. Also, an effect of increasing the cross-link density of the core layer or improving the graft efficiency of the shell layer can be imparted.

Examples of the polyfunctional monomer other than conjugated diene-based monomers such as butadiene, include allylalkyl (meth)acrylates such as allyl (meth)acrylate and allylalkyl (meth)acrylates; allyloxyalkyl (meth)acrylates; polyfunctional (meth)acrylates having two or more (meth)acrylic groups such as (poly)ethylene glycol di(meth)acrylate, butanediol di(meth)acrylate, ethylene glycol di(meth)acrylate, triethylene glycol di(meth)acrylate, and tetraethylene glycol di(meth)acrylate; diallyl phthalate, triallyl cyanurate, triallyl isocyanurate, and divinyl benzene. In particular, allyl methacrylate and/or triallyl isocyanurate are preferable.

In the present disclosure, the term “(meth)acryl” means acryl and/or methacryl.

Shell Layer

The shell layer, which is the outermost layer of the particle of the polymer having a core-shell structure (B1), is constituted by a shell layer polymer obtained by polymerizing a shell-forming monomer. The shell layer polymer plays a role in improving the compatibility between a component consisting of the polymer having a core-shell structure (B1) and a component consisting of the epoxy resin (A) and thus enables the minute particles of the polymer having a core-shell structure (B1) to disperse as primary particles in the curable epoxy resin composition or a cured product thereof.

It is preferable that the shell layer polymer is grafted to the core layer and/or the intermediate layer. It is preferable that the polymer having a core-shell structure (B1) is a polymer obtained through graft polymerization of the shell-forming monomer with the core layer. It should be noted that, in the description below, in the case where the intermediate layer is formed on the core layer, the reference to “grafted to the core layer” also encompasses “grafted to the intermediate layer”. More precisely, it is preferable that the shell layer polymer and the core layer polymer for forming the core layer are substantially chemically bound to each other (of course, it is also preferable that the shell layer polymer binds chemically to an intermediate layer polymer for forming the intermediate layer in the case where the intermediate layer is included) through graft polymerization of the shell layer-forming monomer component to the core layer polymer (of course, this also means the intermediate layer polymer in the case where the intermediate layer is included; the same applies to the following). That is, it is preferable that the shell layer polymer is formed by performing graft polymerization of the shell-forming monomer in the presence of the core layer polymer (this means the core layer polymer on which the intermediate layer has been formed in the case where the intermediate layer is included; the same applies to the following), so that the shell layer polymer is subjected to graft polymerization to the core layer polymer and covers the core layer polymer partially or entirely. This polymerization operation can be carried out by adding a monomer that is a constituent component of the shell layer polymer to a latex of the core layer polymer that is produced as an aqueous polymer latex and performing polymerization.

From the viewpoint of the compatibility and dispersibility of the polymer having a core-shell structure (B1) in the curable epoxy resin composition, the shell layer-forming monomer may be one or more selected from the group consisting of an aromatic vinyl monomer, a vinyl cyan monomer, and a (meth)acrylate monomer, such as one or more selected from the group consisting of an aromatic vinyl monomer and a (meth)acrylate monomer, or a (meth)acrylate monomer, for example. These shell layer-forming monomers may be used alone or in combination of two or more as appropriate.

The total content of the aromatic vinyl monomer, the vinyl cyan monomer, and the (meth)acrylate monomer in 100 mass % of the shell layer-forming monomer may be 10 mass % or more and 99.5 mass % or less, 50 mass % or more and 99 mass % or less, 65 mass % or more and 98 mass % or less, 67 mass % or more and 85 mass % or less, or 67 mass % or more and 80 mass % or less.

From the viewpoint that the polymer having a core-shell structure (B1) maintains a favorable dispersion state in the curable epoxy resin composition or a cured product thereof without aggregating and binds chemically to the epoxy resin (A), it is preferable that a reactive functional group-containing monomer that contains one or more reactive functional groups selected from the group consisting of an epoxy group, an oxetane group, an amino group, an imide group, a carboxylic acid group, a carboxylic acid anhydride group, a cyclic ester, a cyclic amide, a benzoxazine group, and a cyanate group is contained as the shell layer-forming monomer, and a monomer including an epoxy group is more preferable. In other words, it is more preferable that the shell layer includes an epoxy group.

The content of the monomer including an epoxy group in 100 mass % of the shell-forming monomer may be 0.5 mass % or more and 90 mass % or less, 1 mass % or more and 50 mass % or less, 2 mass % or more and 35 mass % or less, or 3 mass % or more and 20 mass % or less. When the content of the monomer including an epoxy group in the shell-forming monomer is within the range described above, an effect of improving the impact resistance of a cured product of the curable epoxy resin composition is likely to be improved, and the curable epoxy resin composition is likely to have favorable impact peel-resistant adhesion. The monomer including an epoxy group may be used to form the shell layer or may be used in only the shell layer.

Also, it is preferable to use a polyfunctional monomer having two or more radical polymerizable double bonds as the shell layer-forming monomer because the particles of the polymer having a core-shell structure (B1) are prevented from swelling in the curable epoxy resin composition, and the curable epoxy resin composition tends to have low viscosity and good handleability at a low temperature such as ordinary temperature. On the other hand, from the viewpoint of the effect of improving the toughness and impact peel-resistant adhesion of a cured product of the curable epoxy resin composition, it is preferable not to use a polyfunctional monomer having two or more radical polymerizable double bonds as the shell layer-forming monomer.

The content of the polyfunctional monomer in 100 mass % of the shell-forming monomer may be 0 mass % or more and 20 mass % or less, for example, 1 mass % or more and 20 mass % or less, or 5 mass % or more and 15 mass % or less.

Examples of the aromatic vinyl monomer include, but are not particularly limited to, vinyl arenes such as styrene, α-methylstyrene, and p-methylstyrene, and vinyl benzenes such as divinyl benzene.

Examples of the vinyl cyan monomer include, but are not particularly limited to, acrylonitrile and methacrylonitrile.

Examples of the (meth)acrylate monomer include, but are not particularly limited to, alkyl (meth)acrylates such as methyl (meth)acrylate, ethyl (meth)acrylate, and butyl (meth)acrylate.

Examples of the monomer including an epoxy group include, but are not particularly limited to, glycidyl group-containing vinyl monomers such as glycidyl (meth)acrylate, 4-hydroxybutyl (meth)acrylate glycidyl ether, and allyl glycidyl ether.

Although the same monomers as the above-described polyfunctional monomers are shown as examples of the polyfunctional monomer having two or more radical polymerizable double bonds, allyl methacrylate and/or triallyl isocyanurate are preferable.

In one or more embodiments of the present invention, it is preferable that the shell layer is formed of a polymer obtained by polymerizing a shell layer-forming monomer (100 mass % in total) that is a combination of the aromatic vinyl monomer (such as styrene) in an amount of 0 mass % or more and 50 mass % or less (1 mass % or more and 50 mass % or less, or 2 mass % or more and 48 mass % or less), the vinyl cyan monomer (such as acrylonitrile) in an amount of 0 mass % or more and 50 mass % or less (0 mass % or more and 30 mass % or less, or 10 mass % or more and 25 mass % or less), the (meth)acrylate monomer (such as methyl methacrylate) in an amount of 0 mass % or more and 99.5 mass % or less (0 mass % or more and 90 mass % or less, or 20 mass % or more and 85 mass % or less), and the monomer including an epoxy group (such as glycidyl methacrylate) in an amount of 0.5 mass % or more and 50 mass % or less (1 mass % or more and 30 mass % or less, or 2 mass % or more and 20 mass % or less), for example. This makes it possible to realize the desired toughness improving effect and mechanical properties in a balanced manner.

The shell layer may include another monomer component in addition to the above-described monomer components. The graft ratio of the shell layer may be 70% or more, 80% or more, or 90% or more. When the graft ratio is 70% or more, an increase in the viscosity of the liquid resin composition is suppressed, and thus favorable handleability is realized. It should be noted that a method for calculating a graft ratio as used herein is as follows.

First, an aqueous latex containing the polymer having a core-shell structure (B1) is solidified and dehydrated, and then dried into a powder of the polymer having a core-shell structure (B1). Next, 2 g of the polymer having a core-shell structure (B1) is immersed in 100 g of methyl ethyl ketone (MEK) at 23° C. for 24 hours, and then MEK soluble matter and MEK insoluble matter are separated. Furthermore, methanol insoluble matter is separated from the MEK soluble matter. The graft ratio is calculated by determining the ratio of the amount of the MEK insoluble matter to the total amount of the MEK insoluble matter and the methanol insoluble matter.

Method for Manufacturing Polymer Having Core-Shell Structure (B1)

Method for Manufacturing Core Layer

When the core layer of the polymer having a core-shell structure (B1) is constituted by diene-based rubber and/or (meth)acrylate-based rubber, that is, the core layer includes at least one monomer (first monomer) selected from the group consisting of a diene-based monomer (specifically a conjugated diene-based monomer) and a (meth)acrylate-based monomer, the core layer can be formed through emulsion polymerization, suspension polymerization, micro-suspension polymerization, or the like, for example, and the method disclosed in WO 2005/028546 A1 can be used for example.

When the polymer for forming the core layer includes a polysiloxane-based polymer, the core layer can be formed through emulsion polymerization, suspension polymerization, micro-suspension polymerization, or the like, for example, and the method disclosed in WO 2006/070664 A1 can be used, for example.

Method for Forming Shell Layer and Intermediate Layer

The intermediate layer can be formed by polymerizing the intermediate layer-forming monomer through known radical polymerization. When the core layer polymer (specifically a rubber elastic body) constituting the core layer is obtained as an emulsion, it is preferable that a monomer having two or more radical polymerizable double bonds is polymerized using an emulsion polymerization method.

The shell layer can be formed by polymerizing the shell layer-forming monomer through known radical polymerization. When the core layer is obtained as the core layer polymer, or the polymers constituting the core layer and the intermediate layer are obtained as emulsions, it is preferable that the shell layer-forming monomer is polymerized using an emulsion polymerization method, and the shell layer can be manufactured in accordance with the method disclosed in WO 2005/028546 A1, for example.

Examples of an emulsifier (dispersant) that can be used in emulsion polymerization include anionic emulsifiers such as various acids (e.g., alkyl sulfonic acids or aryl sulfonic acids typified by dioctyl sulfosuccinic acid and dodecylbenzenesulfonic acid, alkyl ether sulfonic acids or aryl ether sulfonic acids, alkyl sulfuric acids or aryl sulfuric acids typified by dodecyl sulfuric acid, alkyl ether sulfuric acids or aryl sulfuric acids, alkyl-substituted phosphoric acids or aryl-substituted phosphoric acids, alkyl ether-substituted phosphoric acids or aryl ether-substituted phosphoric acids, N-alkyl sarcosine acids or aryl sarcosine acids typified by dodecyl sarcosine acid, alkyl carboxylic acids or aryl carboxylic acids typified by oleic acid and stearic acid, and alkyl ether carboxylic acids or aryl ether carboxylic acids), and alkali metal salts (e.g., sodium salts) or ammonium salts of these acids; nonionic emulsifiers such as alkyl-substituted polyethylene glycol or aryl-substituted polyethylene glycol; polyvinyl alcohol, alkyl-substituted cellulose, polyvinyl pyrrolidone, and polyacrylic acid derivatives. These emulsifiers may be used alone or in combination of two or more.

It is preferable to reduce the amount of the emulsifier that is used as long as the dispersion stability of an aqueous latex of the polymer having a core-shell structure (B1) is not adversely affected. Moreover, the higher the water solubility of the emulsifier, the more preferable. If the water solubility is high, it is easy to remove the emulsifier with water, thus making it easy to prevent an adverse effect on a final cured product.

When the emulsion polymerization method is employed, a known initiator such as 2,2′-azobisisobutyronitrile, hydrogen peroxide, potassium persulfate, or ammonium persulfate can be used as a thermolytic initiator.

It is also possible to use a redox-type initiator containing a combination of a peroxide such as an organic peroxide (e.g., t-butylperoxy isopropyl carbonate, p-menthane hydroperoxide, cumene hydroperoxide, dicumyl peroxide, t-butyl hydroperoxide, di-t-butyl peroxide, or t-hexyl peroxide) or an inorganic peroxide (e.g., hydrogen peroxide, potassium persulfate, or ammonium persulfate), optionally a reducing agent such as sodium formaldehydesulfoxylate or glucose, optionally a transition metal salt such as iron sulfate (II), optionally a chelating agent such as disodium ethylenediaminetetraacetate, and optionally a phosphorus-containing compound such as sodium pyrophosphate.

It is preferable to use a redox-type initiator because polymerization can be performed even at a low temperature at which the peroxide is not substantially thermally decomposed, and the polymerization temperature can be selected from a broad range of temperatures. In particular, it is preferable to use an organic peroxide such as cumene hydroperoxide, dicumyl peroxide, or t-butyl hydroperoxide as the redox-type initiator. The amount of the initiator that is used as well as the amounts of the reducing agent, transition metal salt, chelating agent, and the like that are used in the case where the redox-type initiator is used can be set to be within known ranges. Moreover, when the monomer having two or more radical polymerizable double bonds is polymerized, a known chain transfer agent can be used in an amount within a known range. An additional surfactant can be used, and the amount of the surfactant that is used is also set to be within a known range.

The conditions for polymerization such as the polymerization temperature, pressure, and deoxygenation that are set to be within known ranges can be applied. Moreover, the intermediate layer-forming monomer may be polymerized in a single step or two or more steps. For example, a method in which the intermediate layer-forming monomer is added to an emulsion of the rubber elastic body that is to constitute the elastic core layer in one time, a method in which the intermediate layer-forming monomer is continuously added thereto, a method in which an emulsion of the rubber elastic body that is to constitute the elastic core layer is added to a reactor into which the intermediate layer-forming monomer has been fed in advance and then polymerization is performed, and the like can be employed.

Blocked Isocyanate (B2)

In one or more embodiments of the present invention, the blocked isocyanate (also referred to as a “blocked isocyanate”) (B2) is added to the curable epoxy resin composition, and thus a cured product obtained by curing the resultant curable epoxy resin composition has improved toughness and favorable impact peel-resistant adhesion.

The blocked isocyanate is an elastomer-type compound that includes a urethane group and/or a urea group and isocyanate groups at its terminus and in which a portion or all of the terminal isocyanate groups are capped using various blocking agents including an active hydrogen group. In particular, it is preferable that all of the terminal isocyanate groups are capped with a blocking agent. Such a compound can be obtained by reacting an excessive amount of a polyisocyanate compound with an organic polymer including an active hydrogen-containing group at its terminus to form a polymer (urethane prepolymer) including a urethane group and/or a urea group in the main chain and isocyanate groups at its terminus, and capping all or a portion of the isocyanate groups with a blocking agent including an active hydrogen group thereafter or at the same time.

For example the blocked isocyanate is represented by General Formula (1) below:

A-(NR¹—C(═O)—X)a (1)

(In General Formula (1), the number of R¹s is a and R¹s are individually a hydrocarbon group having 1 to 20 carbon atoms. R¹s (the number of R¹ s is a) may be the same or different. a represents the average number of capped isocyanate groups per molecule, and may be 1.1 or more, 1.5 or more and 8 or less, 1.7 or more and 6 or less, or 2 or more and 4 or less. X is a residue of the blocking agent excluding an active hydrogen atom. A is a residue of a terminal isocyanate-containing prepolymer excluding the terminal isocyanates.).

The hydrocarbon group may be any of an aliphatic hydrocarbon group, an alicyclic hydrocarbon group, and an aromatic hydrocarbon group. Examples of the aliphatic hydrocarbon group include alkyl groups such as a methyl group, an ethyl group, a propyl group, a butyl group, a pentyl group, a hexyl group, a heptyl group, an octyl group, a nonyl group, a decyl group, and a dodecyl group; and alkenyl groups such as an ethenyl group, a propenyl group, a butenyl group, a pentenyl group, a hexenyl group, a heptenyl group, an octenyl group, a nonenyl group, a decenyl group, an undecenyl group, and dodecenyl group. The aliphatic hydrocarbon group may be linear or branched. Examples of the alicyclic hydrocarbon group include cycloalkyl groups such as a cyclopropyl group, a cyclobutyl group, a cyclopentyl group, a cyclohexyl group, a cycloheptyl group, a cyclooctyl group, a cyclononyl group, and a cyclodecyl group; a cyclopropenyl group, a cyclobutenyl group, a cyclopentenyl group, a cyclohexenyl group, a cycloheptenyl group, a cyclooctenyl group, and cyclopentadienyl. Examples of the aromatic hydrocarbon group include a phenyl group, a naphthyl group, an anthryl group, a phenanthryl group, a biphenyl group, and terphenyl group.

When represented as a polystyrene converted molecular weight measured using GPC, the number average molecular weight of the blocked isocyanate may be 2000 or more and 40000 or less, 3000 or more and 30000 or less, or 4000 or more and 20000 or less. The molecular weight distribution (a ratio between the weight average molecular weight and the number average molecular weight) may be 1 or more and 4 or less, 1.2 or more and 3 or less, or 1.5 or more and 2.5 or less.

Organic Polymer Including Active Hydrogen-Containing Group at Its Terminus

Examples of a main chain skeleton included in the organic polymer including an active hydrogen-containing group at its terminus include polyether-based polymers, polyacryl-based polymers, polyester-based polymers, polydiene-based polymers, saturated hydrocarbon-based polymers (polyolefins), and polythioether-based polymers.

Examples of an active hydrogen-containing group included in the organic polymer including an active hydrogen-containing group at its terminus include a hydroxyl group, an amino group, an imino group, and a thiol group. Among these groups, a hydroxyl group, an amino group, and an imino group are preferable from the viewpoint of availability, and a hydroxyl group is more preferable from the viewpoint of the handleability (viscosity) of the blocked isocyanate.

Examples of the organic polymer including an active hydrogen-containing group at its terminus include polyether-based polymers including a hydroxyl group at their termini (polyether polyols), polyether-based polymers having an amino group and/or an imino group at their termini (polyether amines), polyacrylic polyols, polyester polyols, diene-based polymers including a hydroxyl group at their termini (polydiene polyols), saturated hydrocarbon-based polymers including a hydroxyl group at their termini (polyolefin polyols), polythiol compounds, and polyamine compounds. Among these compounds, polyether polyols, polyether amines, and polyacrylic polyols are preferable because they have excellent compatibility with the epoxy resin (A), the organic polymers have a relatively low glass-transition temperature, and a cured product of the curable epoxy resin composition has excellent impact resistance at low temperatures. In particular, polyether polyols and polyether amines are more preferable because the resultant organic polymers have low viscosity and favorable workability, and polyether polyols are particularly preferable.

The organic polymers including an active hydrogen-containing group at their termini that are used to produce a urethane prepolymer serving as a precursor of the blocked isocyanate may be used alone or in combination of two or more.

The number average molecular weight of the organic polymer including an active hydrogen-containing group at its terminus may be 800 or more and 7000 or less, 1500 or more and 5000 or less, or 2000 or more and 4000 or less in polystyrene conversion as measured by gel permeation chromatography (GPC).

The polyether-based polymers are polymers that essentially include repeating units represented by General Formula (2):

—R²—O— (2)

and R² in General Formula (2) may be a linear or branched alkylene group having 1 to 14 carbon atoms, or 2 to 4 carbon atoms. Specific examples of the repeating units represented by General Formula (2) include —CH₂O—, —CH₂CH₂O—, —CH₂CH(CH₃)O—, CH₂CH(C₂H₅)O—, —CH₂C(CH₃)₂O—, and —CH₂CH₂CH₂CH₂O—. The polyether-based polymers may have a main chain skeleton including only one type of repeating unit or two or more types of repeating units. In particular, a polyether-based polymer constituted by a polymer that includes polypropylene glycol as a main component and includes repeating units of propylene oxide in an amount of 50 mass % or more is preferable from the viewpoint of the Tpeel adhesive strength. Also, a polyether-based polymer constituted by a polymer that includes polytetramethylene glycol (PTMG) obtained through ring-opening polymerization of tetrahydrofuran as a main component is preferable from the viewpoint of dynamic splitting resistance.

Examples of the polyacrylic polyols include polyols that have a skeleton constituted by an alkyl (meth)acrylate (co)polymer and include a hydroxyl group in their molecules. In particular, polacrylic polyols obtained by copolymerizing a hydroxyl group-containing alkyl (meth)acrylate monomer such as 2-hydroxyethyl methacrylate are preferable.

Examples of the polyester polyols include polymers obtained through polycondensation of a polybasic acid such as maleic acid, fumaric acid, adipic acid or phthalic acid, or an acid anhydride thereof and polyhydric alcohol such as ethylene glycol, propylene glycol,1,4-butanediol, 1,6-hexanediol, diethylene glycol, dipropylene glycol, and neopentyl glycol performed in the presence of an esterification catalyst within a temperature range of 150° C. or higher to 270° C. or lower. Also, examples thereof include ring-opened polymers such as ε-caprolactone and valerolactone, and active hydrogen compounds including two or more active hydrogen atoms such as polycarbonate diol and castor oil.

Examples of the polydiene polyols include polybutadiene polyol, polyisoprene polyol, and polychloroprene polyol, and in particular, polybutadiene polyol is preferable.

Examples of the polyolefin polyols include polyisobutylene polyol and hydrogenated polybutadiene polyol.

Polyisocyanate Compound

Specific examples of the polyisocyanate compound include aromatic polyisocyanates such as toluene (tolylene) diisocyanate, diphenylmethane diisocyanate, and xylylene diisocyanate; and aliphatic polyisocyanates such as isophorone diisocyanate, hexamethylene diisocyanate, hydrogenated toluene diisocyanate, and hydrogenated diphenylmethane diisocyanate. Among these compounds, the aliphatic polyisocyanates are preferable from the viewpoint of heat resistance, and isophorone diisocyanate and hexamethylene diisocyanate are more preferable from the viewpoint of availability.

Blocking Agent

Examples of the blocking agent include primary amine-based blocking agents, secondary amine-based blocking agents, oxime-based blocking agents, lactam-based blocking agents, active methylene-based blocking agents, alcohol-based blocking agents, mercaptan-based blocking agents, amide-based blocking agents, imide-based blocking agents, heterocyclic aromatic compound-based blocking agents, hydroxy-functional (meth)acrylate-based blocking agents, and phenol-based blocking agents. Among these blocking agents, oxime-based blocking agents, lactam-based blocking agents, hydroxy-functional (meth)acrylate-based blocking agents, and phenol-based blocking agents are preferable, hydroxy-functional (meth)acrylate-based blocking agents and phenol-based blocking agents are more preferable, and phenol-based blocking agents are even more preferable.

Examples of the primary amine-based blocking agents include butylamine, isopropylamine, dodecylamine, cyclohexylamine, aniline, and benzylamme. Examples of the secondary amine-based blocking agents include dibutylamine, diisopropylamine, dicyclohexylamine, diphenylamine, dibenzylamine, morpholine, and piperidine. Examples of the oxime-based blocking agents include formaldoxime, acetaldoxime, acetoxime, methylethylketoxime, diacetyl monooxime, and cyclohexane oxime. Examples of the lactam-based blocking agents include ε-caprolactam, δ-valerolactam, γ-butyrolactam, and β-butyrolactam. Examples of the active methylene-based blocking agents include ethyl acetoacetate and acetylacetone. Examples of the alcohol-based blocking agents include methanol, ethanol, propanol, isopropanol, butanol, amyl alcohol, cyclohexanol, 1-methoxy-2-propanol, ethylene glycol monomethyl ether, ethylene glycol monoethyl ether, propylene glycol monomethyl ether, benzyl alcohol, methyl glycolate, butyl glycolate, diacetone alcohol, methyl lactate, and ethyl lactate. Examples of the mercaptan-based blocking agents include butyl mercaptan, hexyl mercaptan, decyl mercaptan, t-butyl mercaptan, thiophenol, methyl thiophenol, and ethyl thiophenol. Examples of the amide-based blocking agents include amide acetate and benzamide. Examples of the imide-based blocking agents include imide succinate and imide maleate. Examples of the heterocyclic aromatic compound-based blocking agents include imidazoles such as imidazole and 2-ethylimidazole, pyrroles such as pyrrole, 2-methylpyrrole, and 3-methylpyrrole, pyridines such as pyridine, 2-methylpyridine, and 4-methylpyridine, and diazabicyclo alkenes such as diazabicycloundecene and diazabicyclononene.

The hydroxy-functional (meth)acrylate-based blocking agents are (meth)acrylates including one or more hydroxyl groups, for example. Specific examples thereof include 2-hydroxyethyl (meth)acrylate, 2-hydroxypropyl (meth)acrylate, 4-hydroxybutyl (meth)acrylate, and 2-hydroxybutyl (meth)acrylate.

It is preferable that the phenol-based blocking agents include at least one phenolic hydroxyl group, that is, a hydroxyl group that links directly to a carbon atom in an aromatic ring. Although the phenolic compounds may include two or more phenolic hydroxyl groups, it is preferable that the phenolic compounds include only one phenolic hydroxyl group. Although the phenolic compounds may include other substituents, it is preferable that these substituents do not react with an isocyanate group under the conditions of a capping reaction, and an alkenyl group and an allyl group are preferable. Examples of other substituents include alkyl groups such as linear alkyl, branched alkyl, and cycloalkyl; aromatic groups (e.g., phenyl, alkyl-substituted phenyl, and alkenyl-substituted phenyl); aryl-substituted alkyl groups; and phenol-substituted alkyl groups. Specific examples of the phenol-based blocking agents include phenol, cresol, xylenol, chlorophenol, ethylphenol, allylphenol (particularly o-allylphenol), resorcinol, catechol, hydroquinone, bisphenol, bisphenol A, bisphenol AP (1,1-bis(4-hydroxylphenyl)-1-phenylethane), bisphenol F, bisphenol K, bisphenol M, tetramethylbiphenol, and 2,2′-diallyl-bisphenol A.

It is preferable that each of the blocking agents links to the terminus of the polymer chain of the urethane prepolymer such that the terminus to which the blocking agent is linked no longer includes a reactive group. The blocking agents may be used alone or in combination of two or more. The blocked isocyanate may include a residue of a cross-linking agent, a residue of a chain extending agent, or both.

The blocked isocyanate may be a compound obtained by capping a urethane prepolymer having a polyalkylene glycol structure with a blocking agent, or a compound obtained by capping a urethane prepolymer having a polypropylene glycol structure with a blocking agent (such as a phenol-based blocking agent) or a compound obtained by capping a urethane prepolymer having a polytetramethylene glycol structure with a blocking agent (such as a phenol-based blocking agent). The blocked isocyanate can be favorably used to improve the thixotropy and adhesion. The compound obtained by capping a urethane prepolymer having a polypropylene glycol structure with a blocking agent (such as a phenol-based blocking agent) may be used from the viewpoint of improving the dynamic splitting resistance as well as the T-peel adhesion strength, and the compound obtained by capping a urethane prepolymer having a polytetramethylene glycol structure with a blocking agent (such as a phenol-based blocking agent) may be used from the viewpoint that the dynamic splitting resistance is further improved compared with the case where the compound obtained by capping a urethane prepolymer having a polypropylene glycol structure with a blocking agent (such as a phenol-based blocking agent) is used.

The blocked NCO equivalent of the blocked isocyanate may be 300 g/eq or more and 3000 g/eq or less, for example, or 500 g/eq or more and 2000 g/eq or less. A blocked isocyanate that develops at least one of these properties can be favorably used in one or more embodiments of the present invention.

The cross-linking agent may have a molecular weight of 750 or less, or a molecular weight of 50 or more and 500 or less. In addition, the cross-linking agent may be a polyol compound including at least three hydroxyl groups per molecule or a polyamine compound including an amino group and/or an imino group. The cross-linking agent is useful for imparting branches to the blocked isocyanate and increasing the functionality (i.e., the number of capped isocyanate groups per molecule) of the blocked isocyanate.

The chain extending agent may have a molecular weight of 750 or less, or a molecular weight of 50 or more and 500 or less. In addition, the chain extending agent may be a polyol compound including two hydroxyl groups per molecule or a polyamine compound including an amino group and/or an imino group. The chain extending agent is useful for increasing the molecular weight of the blocked isocyanate without increasing the functionality thereof.

Specific examples of the cross-linking agent and the chain-extending agent include trimethylolpropane, glycerin, trimethylolethane, ethylene glycol, diethylene glycol, propylene glycol, dipropylene glycol, sucrose, sorbitol, pentaerythritol, ethylenediamine, triethanolamine, monoethanolamine, diethanolamine, piperazine, and aminoethylpiperazine. Also, specific examples thereof include compounds including two or more phenolic hydroxyl groups, such as resorcinol, catechol, hydroquinone, bisphenol, bisphenolA, bisphenolAP (1,1-bis(4-hydroxylphenyl)-1-phenylethane), bisphenol F, bisphenol K, bisphenol M, tetramethylbiphenol, and 2,2′-diallyl-bisphenol A

The amount of the blocked isocyanate (B2) that is used may be 1 part by mass or more and 100 parts by mass or less, 2 parts by mass or more and 50 parts by mass or less, 3 parts by mass or more and 40 parts by mass or less, or 5 parts by mass or more and 30 parts by mass or less, relative to 100 parts by mass of the epoxy resin (A).

When the amount of the blocked isocyanate (B2) that is used is 1 part by mass or more, a cured product of the curable epoxy resin composition has improved toughness and favorable impact peel-resistant adhesion. When the amount of the blocked isocyanate (B2) that is used is 100 parts by mass or less, a cured product of the curable epoxy resin composition has favorable heat resistance and elastic modulus (rigidity). One type of blocked isocyanate (B2) may be used alone, or two or more types of blocked isocyanates (B2) may be used in combination.

When the blocked isocyanate (B2) and the polymer having a core-shell structure (B1) are used together, a mass ratio of the polymer having a core-shell structure (B1) to the blocked isocyanate (B2) (polymer having a core-shell structure (B1)/blocked isocyanate (B2)) may be 0.1 or more and 10 or less, 0.2 or more and 5 or less, 0.3 or more and 4 or less, or 1 or more and 3 or less.

Rubber-Modified Epoxy Resin (B3)

The rubber-modified epoxy resin (B3) is a reaction product that is obtained by reacting rubber with an epoxy group-containing compound and may include 1.1 or more, or 2 or more, epoxy groups per molecule on average. Examples of the rubber include acrylonitrile-butadiene rubber (NBR), styrene-butadiene rubber (SBR), hydrogenated nitrile rubber (HNBR), ethylene-propylene rubber (EPDM), acrylic rubber (ACM), butyl rubber (IIR), butadiene rubber, and rubber-based polymers such as polyoxyalkylenes (e.g., polypropylene oxide, polyethylene oxide, and polytetramethylene oxide). It is preferable that the rubber-based polymers include a reactive group such as an amino group, a hydroxyl group, or a carboxyl group at their termini. Products obtained by reacting these rubber-based polymers with an epoxy resin with an appropriate blend ratio in accordance with a known method serve as the rubber-modified epoxy resin to be used in the curable epoxy resin composition in one or more embodiments of the present invention. Among these products, an acrylonitrile-butadiene rubber-modified epoxy resin and/or a polyoxyalkylene-modified epoxy resin are preferable from the viewpoint of the adhesion and the impact peel-resistant adhesion of the curable epoxy resin composition, and an acrylonitrile-butadiene rubber-modified epoxy resin is more preferable. It should be noted that an acrylonitrile-butadiene rubber-modified epoxy resin is obtained through a reaction between carboxyl group terminated NBR (CTBN) and a bisphenol A-type epoxy resin, for example.

The content of the acrylonitrile monomer component in 100 mass % of the acrylonitrile-butadiene rubber may be 5 mass % or more and 40 mass or less, 10 mass % or more and 35 mass % or less, or 15 mass % or more and 30 mass % or less, from the viewpoint of the adhesion and the impact peel-resistant adhesion of the curable epoxy resin composition. The content thereof may be 20 mass % or more and 30 mass % or less from the viewpoint of the workability of the resultant curable epoxy resin composition.

Moreover, for example, the rubber-modified epoxy resin also encompasses an addition reaction product (also referred to as an “adduct” hereinafter) obtained through an addition reaction between amino group-terminated polyoxyalkylene and an epoxy resin. The adduct can be easily manufactured using a known method as disclosed in U.S. Pat. Nos. 5,084,532 and 6,015,865, for example. The specific examples of the (A) component shown in this specification as examples can be used as the epoxy resin to manufacture the adduct, and a bisphenol A-type epoxy resin and a bisphenol F-type epoxy resin are preferable, and a bisphenol A-type epoxy resin is more preferable. Examples of commercially available amino group-terminated polyoxyalkylenes to be used to manufacture the adduct include “Jeffamine D-230”, “Jeffamine D-400”, “Jeffamine D-2000”, “Jeffamine D-4000”, and “Jeffamine T-5000”, which are manufactured by Huntsman.

The average number of epoxide reactive terminal groups per molecule of the rubber may be 1.5 or more and 2.5 or less, and 1.8 or more and 2.2 or less. The number average molecular weight of the rubber may be 1000 or more and 10000 or less, 2000 or more and 8000 or less, or 3000 or more and 6000 or less in polystyrene conversion as measured by gel permeation chromatography (GPC).

There is no particular limitation on a method for manufacturing the rubber-modified epoxy resin (B3), and the rubber-modified epoxy resin (B3) can be manufactured by reacting rubber and an epoxy group-containing compound in a large amount of the epoxy group-containing compound, for example. Specifically, it is preferable to manufacture the rubber-modified epoxy resin (B3) by reacting 2 or more equivalents of the epoxy group-containing compound with 1 equivalent of the epoxy reactive terminal group in the rubber. It is more preferable to use the epoxy group-containing compound in the reaction in an amount that is sufficient enough to obtain the product as a mixture of an adduct between the rubber and the epoxy group-containing compound and the free epoxy group-containing compound. For example, the rubber-modified epoxy resin can be manufactured through heating to a temperature of 100° C. or higher and 250° C. or lower in the presence of a catalyst such as phenyldimethyl urea or triphenylphosphine. Although there is no particular limitation on the epoxy group-containing compound to be used to manufacture the rubber-modified epoxy resin, a bisphenol A-type epoxy resin and a bisphenol F-type epoxy resin are preferable, and a bisphenol A-type epoxy resin is more preferable. It should be noted that, in one or more embodiments of the present invention, when an excessive amount of the epoxy group-containing compound is used to manufacture the rubber-modified epoxy resin, the unreacted epoxy group-containing compound that remains after the reaction is not considered to be contained in the rubber-modified epoxy resin used in one or more embodiments of the present invention.

Regarding the rubber-modified epoxy resin (B3), a preliminary reaction with a bisphenol component makes it possible to reform the epoxy resin. The amount of the bisphenol component used for reformation may be 3 parts by mass or more and 35 parts by mass or less, or 5 parts by mass or more and 25 parts by mass or less, relative to 100 parts by mass of the rubber component in the rubber-modified epoxy resin. A cured product of the curable epoxy resin composition containing the reformed rubber-modified epoxy resin has excellent adhesion durability after exposure to high temperatures as well as excellent impact resistance at low temperatures.

There is no particular limitation on the glass-transition temperature (Tg) of the rubber-modified epoxy resin (B3), but it may be −25° C. or lower, −35° C. or lower, −40° C. or lower, or −50° C. or lower.

The number average molecular weight of the rubber-modified epoxy resin (B3) may be 1500 or more and 40000 or less, 3000 or more and 30000 or less, or 4000 or more and 20000 or less in polystyrene conversion as measured by gel permeation chromatography (GPC). The molecular weight distribution (a ratio between the weight average molecular weight and the number average molecular weight) may be 1 or more and 4 or less, 1.2 or more and 3 or less, or 1.5 or more and 2.5 or less.

The amount of the rubber-modified epoxy resin (B3) that is used may be 1 part by mass or more and 50 parts by mass or less, 2 parts by mass or more and 40 parts by mass or less, 5 parts by mass or more and 30 parts by mass or less, or 10 parts by mass or more and 20 parts by mass or less, relative to 100 parts by mass of the epoxy resin (A). When the amount of the rubber-modified epoxy resin (B3) that is used is 1 part by mass or more, a cured product of the curable epoxy resin composition has improved toughness and favorable impact peel-resistant adhesion. When the amount of the rubber-modified epoxy resin (B3) that is used is 50 parts by mass or less, a cured product of the curable epoxy resin composition has favorable heat resistance and elastic modulus (rigidity). One type of rubber-modified epoxy resin (B3) may be used alone, or two or more types of rubber-modified epoxy resins (B3) may be used in combination.

Urethane-Modified Epoxy Resin (B4)

The urethane-modified epoxy resin (B4) is a reaction product that is obtained by reacting a compound including an epoxy group and a group reactive with an isocyanate group with a urethane prepolymer including an isocyanate group and may include 1.1 or more, or 2 or more, epoxy groups per molecule on average. For example, a urethane-modified epoxy resin is obtained by reacting a hydroxyl group-containing epoxy compound with a urethane prepolymer.

The number average molecular weight of the urethane-modified epoxy resin (B4) may be 1500 or more and 40000 or less, 3000 or more and 30000 or less, or 4000 or more and 20000 or less in polystyrene conversion as measured by gel permeation chromatography (GPC). The molecular weight distribution (a ratio between the weight average molecular weight and the number average molecular weight) may be 1 or more and 4 or less, 1.2 or more and 3 or less, or 1.5 or more and 2.5 or less.

The amount of the urethane-modified epoxy resin (B4) that is used may be 1 part by mass or more and 50 parts by mass or less, 2 parts by mass or more and 40 parts by mass or less, 5 parts by mass or more and 30 parts by mass or less, or 10 parts by mass or more and 20 parts by mass or less, relative to 100 parts by mass of the (A) component. When the amount of the urethane-modified epoxy resin (B4) that is used is 1 part by mass or more, a cured product of the curable epoxy resin composition has improved toughness and favorable impact peel-resistant adhesion. When the amount of the urethane-modified epoxy resin (B4) that is used is 50 parts by mass or less, a cured product of the curable epoxy resin composition has favorable heat resistance and elastic modulus (rigidity). One type of urethane-modified epoxy resin (B4) may be used alone, or two or more types of urethane-modified epoxy resins (B4) may be used in combination.

Dimer Acid-Modified Epoxy Resin (B5)

The dimer acid-modified epoxy resin (B5) is an epoxy resin modified with a dimer acid. Specifically, at least one carboxyl group in a dimer acid structure reacts with a polyfunctional epoxy resin.

The dimer acid is a dimer of an unsaturated fatty acid, and there is no particular limitation on the unsaturated fatty acid used as a raw material. Examples of the unsaturated fatty acid include unsaturated fatty acids having 24 or less carbon atoms, such as oleic acid, elaidic acid, cetoleic acid, sorbic acid, linoleic acid, linolenic acid, and arachidonic acid, and plant-derived oil containing these unsaturated fatty acids as a main component can be used as appropriate. The dimer acid can be produced through thermal polymerization of two molecules of an unsaturated fatty acid, and even a dimer acid containing a by-product trimer acid can also be used. Furthermore, partially or fully hydrogenated dimer acids, C21 carboxylic acids obtained through thermal polymerization of an unsaturated fatty acid and acrylic acid, and the like can also be used. The dimer acid may have a cyclic structure or non-cyclic structure. Commercially available dimer acids such as HARIDIMER 200 and HARIDIMER 300 (manufactured by Harima Chemicals Group, Inc.), PRIPOL 1017 and PRIPOL 1098 (manufactured by Unichema), EMPOL 1008 and EMPOL 1062 (manufactured by Cognis), DIACID 1550 (manufactured by Harima Chemicals Group, Inc.), and UNIDYME 27 (manufactured by Arizona Chemical) may also be used as the dimer acid.

There is also no particular limitation on the type of epoxy resin, and various epoxy resins such as bisphenol-type epoxy resins, ether ester-type epoxy resins, novolak epoxy-type epoxy resins, ester-type epoxy resins, aliphatic epoxy resins, and aromatic epoxy resins can be used as appropriate.

The epoxy equivalent of the dimer acid-modified epoxy resin (B5) may be within a range of 100 g/eq or more to 800 g/eq or less. Moreover, there is no particular limitation on the mass average molecular weight of the dimer acid-modified epoxy resin (B5), and it may be selected as appropriate depending on the application thereof. The mass average molecular weight thereof may be within a range of 300 or more to 2000 or less in polystyrene conversion as measured by gel permeation chromatography (GPC).

Commercially available dimer acid-modified epoxy resins such as “jER871” (product name; the same applies the following) and “jER872” manufactured by Mitsubishi Chemical Corporation, and “YD-171” and “YD-172” manufactured by New Nippon Steel Chemical Co., Ltd. may also be used as the dimer acid-modified epoxy resin (B5). Also, an addition reaction product obtained through an addition reaction between a dimer (dimer acid) of tall oil fatty acid and a bisphenol A-type epoxy resin as disclosed in WO 2010/098950 A1 may be used, for example.

The amount of the dimer acid-modified epoxy resin (B5) that is used may be 1 part by mass or more and 60 parts by mass or less, 2 parts by mass or more and 50 parts by mass or less, 5 parts by mass or more and 40 parts by mass or less, or 10 parts by mass or more and 30 parts by mass or less, relative to 100 parts by mass of the (A) component. When the amount of the dimer acid-modified epoxy resin (B5) that is used is 1 part by mass or more, a cured product of the curable epoxy resin composition has improved toughness and favorable impact peel-resistant adhesion. When the amount of the dimer acid-modified epoxy resin (B5) that is used is 60 parts by mass or less, a cured product of the curable epoxy resin composition has favorable heat resistance and elastic modulus (rigidity). One type of dimer acid-modified epoxy resin (B5) may be used alone, or two or more types of dimer acid-modified epoxy resins (B5) may be used in combination.

Carboxyl Group-Containing Non-Cross-Linked Acrylic Resin (C)

It is sufficient that the carboxyl group-containing non-cross-linked acrylic resin (C) is a non-cross-linked acryl-based resin including a carboxyl group, and there is no particular limitation thereon. Examples thereof include acryl-based resins obtained by copolymerizing monomers including a carboxyl group, acryl-based resins obtained by homopolymerizing a monomer including a carboxyl group, and acryl-based resins obtained by reacting a functional group of an acryl-based resin including a functional group and a compound including both a carboxyl group and a functional group reactive with the functional group of the acryl-based resin (and then modifying the resultant reaction product). In particular, it is preferable to use a copolymer obtained by copolymerizing a monomer including a carboxyl group with another copolymerization component or a homopolymer obtained by homopolymerizing a monomer including a carboxyl group as the carboxyl group-containing non-cross-linked acrylic resin (C) because such polymers can be easily manufactured industrially, and it is more preferable to use a copolymer obtained by copolymerizing a monomer including a carboxyl group with another copolymerization component.

There is no particular limitation on the monomer including a carboxyl group, and examples thereof include (meth)acrylic acid, crotonic acid, maleic acid, maleic anhydride, itaconic acid, fumaric acid, acrylamide N-glycolic acid, cinnamic acid, Michael adducts of (meth)acrylic acid, 2-(meth)acryloyloxyethyl dicarboxylate monoester, and 2-carboxyethyl acrylate. Examples of the Michael adducts of (meth)acrylic acid include an acrylate dimer, a methacrylate dimer, an acrylate trimer, a methacrylate trimer, an acrylate tetramer, and a methacrylate tetramer. Examples of the 2-(meth)acryloyloxyethyl dicarboxylate monoester include 2-acryloyloxyethyl succinate monoester, 2-methacryloyloxyethyl succinate monoester, 2-acryloyloxyethyl phthalate monoester, 2-methacryloyloxyethyl phthalate monoester, 2-acryloyloxyethyl hexahydrophthalate monoester, and 2-methacryloyloxyethyl hexahydrophthalate monoester. Among the above-mentioned monomers including a carboxyl group, one or more monomers selected from the group consisting of (meth)acrylic acid, crotonic acid, maleic acid, maleic anhydride, itaconic acid, fumaric acid, and the Michael adducts of (meth)acrylic acid are preferable from the viewpoint that they are readily available and can be stably manufactured. The monomers including a carboxyl group may be used alone or in combination of two or more.

Regarding the carboxyl group-containing non-cross-linked acrylic resin (C), when the monomer including a carboxyl group is copolymerized with another monomer component, and the total amount of the copolymerization components is taken as 100 mass %, the content of the monomer including a carboxyl group may be 0.5 mass % or more and 30 mass % or less, 1 mass % or more and 20 mass % or less, 1.5 mass % or more and 15 mass % or less, or 2 mass % or more and 10 mass % or less. When the content of the monomer including a carboxyl group is within the range described above, the solubility in the epoxy resin (A) at a high temperature is favorable.

Examples of the monomer component other than the monomer including a carboxyl group include alkyl (meth)acrylate-based monomers. Although there is no particular limitation on the alkyl (meth)acrylate-based monomers, the number of carbon atoms of the alkyl group may be 1 or more and 20 or less, 1 or more and 12 or less, or 1 or more and 8 or less. Specific examples thereof include methyl (meth)acrylate, ethyl (meth)acrylate, n-butyl (meth)acrylate, iso-butyl (meth)acrylate, tert-butyl (meth)acrylate, n-propyl (meth)acrylate, n-hexyl(meth)acrylate, 2-ethylhexyl (meth)acrylate, n-octyl (meth)acrylate, isodecyl (meth)acrylate, lauryl (meth)acrylate, cetyl (meth)acrylate, stearyl (meth)acrylate, cyclohexyl (meth)acrylate, and isobornyl (meth)acrylate. Among these acrylates, methyl (meth)acrylate, n-butyl (meth)acrylate, and 2-ethylhexyl (meth)acrylate may be used from the viewpoint of copolymerizability, handleability, and availability of raw materials. These acrylates may be used alone or in combination of two or more.

Regarding the carboxyl group-containing non-cross-linked acrylic resin (C), when the total amount of the copolymerization components is taken as 100 mass %, the total content of the monomer including a carboxyl group and the (meth)acrylate-based monomer may be 70 mass % or more and 100 mass % or less, 85 mass % or more and 100 mass % or less, or 90 mass % or more and 100 mass % or less.

In addition to the (meth)acrylate-based monomer, another vinyl-based monomer such as an aromatic vinyl monomer, a vinyl cyanide monomer, a vinyl ester, a vinyl halide, or a vinylidene halide can be contained as the monomer component other than the monomer including a carboxyl group as needed. Examples of the aromatic vinyl monomer include styrene, vinyltoluene, and α-methylstyrene, examples of the vinyl cyanide monomer include acrylonitrile and methacrylonitrile, examples of the vinyl ester include vinyl formate, vinyl acetate, and vinyl propionate, examples of the vinyl halide include vinyl chloride and vinyl bromide, and examples of the vinylidene halide include vinylidene chloride and vinylidene fluoride. These vinyl-based monomers may be used alone or in combination of two or more.

Regarding the carboxyl group-containing non-cross-linked acrylic resin (C), when the total amount of the copolymerization components is taken as 100 mass %, the amount of the other vinyl monomer may be 0 mass % or more and 30 mass % or less, 0 mass % or more and 15 mass % or less, or 0 mass % or more and 10 mass % or less, for example.

The carboxyl group-containing non-cross-linked acrylic resin (C) can be formed using a conventionally known method such as solution radical polymerization, suspension polymerization, bulk polymerization, or emulsion polymerization. For example, in the case of emulsion polymerization, the same dispersant, initiator, and the like as those used in the polymerization of the shell layer-forming monomer for the above-described polymer having a core-shell structure (B1) can be used.

In the carboxyl group-containing non-cross-linked acrylic resin (C), the content of the carboxyl group may be 0.05 mmol/g or more and 5.0 mmol/g or less, 0.10 mmol/g or more and 4.0 mmol/g or less, or 0.15 mmol/g or more and 3.0 mmol/g or less. When the content of the carboxyl group is within the range described above, the carboxyl group-containing non-cross-linked acrylic resin (C) is less likely to dissolve in the epoxy resin (A) at a low temperature around room temperature but is likely to dissolve in the epoxy resin (A) and thus improve the viscosity of the curable epoxy resin composition at a high temperature, and therefore, the moisture absorption-induced foaming-resistant effect is more likely to be exhibited. The content of the carboxyl group in the carboxyl group-containing non-cross-linked acrylic resin (C) can be measured as described later.

The weight average molecular weight of the carboxyl group-containing non-cross-linked acrylic resin (C) may be 50,000 or more and 10,000,000 or less, 100,000 or more and 7,000,000 or less, 300,000 or more and 5,000,000 or less, 500,000 or more and 3,000,000 or less, or 600,000 or more and 2,000,000 or less in polystyrene conversion as measured by gel permeation chromatography (GPC). When the weight average molecular weight is within the range described above, the carboxyl group-containing non-cross-linked acrylic resin (C) is less likely to dissolve in the epoxy resin (A) at a low temperature around room temperature but is likely to dissolve in the epoxy resin (A) and thus improve the viscosity of the curable epoxy resin composition at a high temperature, and therefore, the moisture absorption-induced foaming-resistant effect is more likely to be exhibited.

The glass-transition temperature of the carboxyl group-containing non-cross-linked acrylic resin (C) may be 50° C. or higher and 150° C. or lower, 60° C. or higher and 140° C. or lower, or 70° C. or higher and 130° C. or lower. When the glass-transition temperature is within the range described above, the carboxyl group-containing non-cross-linked acrylic resin (C) is less likely to dissolve in the epoxy resin (A) at a low temperature around room temperature but is likely to dissolve in the epoxy resin (A) and thus improve the viscosity of the curable epoxy resin composition at a high temperature, and therefore, the moisture absorption-induced foaming-resistant effect is more likely to be exhibited.

The carboxyl group-containing non-cross-linked acrylic resin (C) may contain MEK soluble matter in an amount of 30 mass % or more and 100 mass % or less, 50 mass or more and 100 mass % or less, or 70 mass % or more and 100 mass % or less. When the content of the MEK soluble matter is within the range described above, the carboxyl group-containing non-cross-linked acrylic resin (C) is less likely to dissolve in the epoxy resin (A) at a low temperature around room temperature but is likely to dissolve in the epoxy resin (A) and thus improve the viscosity of the curable epoxy resin composition at a high temperature, and therefore, the moisture absorption-induced foaming-resistant effect is more likely to be exhibited.

The amount of the carboxyl group-containing non-cross-linked acrylic resin (C) that is used is not limited as long as the carboxyl group-containing non-cross-linked acrylic resin (C) can exhibit an effect of increasing the viscosity at a high temperature of 100° C. or higher, and may be 2.5 parts by mass or more, 3 parts by mass or more, 3.5 parts by mass or more, or 4 parts by mass or more, relative to 100 parts by mass of the (A) component. Also, the amount of the carboxyl group-containing non-cross-linked acrylic resin (C) that is used may be 100 parts by mass or less, 80 parts by mass or less, 50 parts by mass or less, 40 parts by mass or less, or 30 parts by mass or less, from the viewpoint of handleability during the production of the curable epoxy resin composition. Specifically, the amount of the carboxyl group-containing non-cross-linked acrylic resin (C) may be 2.5 parts by mass or more and 100 parts by mass or less, 3 parts by mass or more and 50 parts by mass or less, 3.5 parts by mass or more and 40 parts by mass or less, or 4 parts by mass or more and 30 parts by mass or less, relative to 100 parts by mass of the (A) component.

Epoxy Curing Agent (D)

In one or more embodiments of the present invention, the curable epoxy resin composition may contain an epoxy curing agent (D) as needed. In one or more embodiments of the present invention, when the curable epoxy resin composition is used as a one-component-type composition such as a one-component curable epoxy resin composition, it is preferable to select a (D) component with which the curable epoxy resin composition is rapidly cured when heated to a temperature of 80° C. or higher, and more preferable to select a (D) component with which the curable epoxy resin composition is rapidly cured when heated to a temperature of 140° C. or higher. On the contrary, it is preferable to select a (D) component and an (E) component (which will be described later) with which the curable epoxy resin composition is cured very slowly even if the curable epoxy resin composition is cured at room temperature (about 22° C.) or a temperature of lower than at least 50° C.

A component that exhibits activity when heated (also referred to as a “latent curing agent”) can be used as the epoxy curing agent (D). A latent epoxy curing agent is preferable because the curable epoxy resin composition can be used as a one-solution-type. N-containing curing agents such as specific amine-based curing agents (including imine-based curing agents) can be used as such a latent epoxy curing agent, and examples thereof include a boron trichloride/amine complex, a boron trifluorid/amine complex, dicyandiamide, melamine, diallylmelamine, guanamine (e.g., acetoguanamine and benzoguanamine), aminotriazole (e.g., 3-amino-1,2,4-triazole), hydrazide (e.g., adipic dihydrazide, stearic dihydrazide, isophthalic dihydrazide, and semicarbazide), cyanoacetamide, and aromatic polyamine (e.g., m-phenylenediamine, diaminodiphenylmethane, and diaminodiphenyl sulfone). It is preferable to use dicyandiamide, isophthalic dihydrazide, adipic dihydrazide, and 4,4′-diaminodiphenyl sulfone, and dicyandiamide is particularly preferable.

In one or more embodiments of the present invention, the amount of the latent epoxy curing agent (dicyandiamide) that is used in the curable epoxy resin composition may be 1 part by mass or more and 10 parts by mass or less, 5 parts by mass or more and 9 parts by mass or less, or 6 parts by mass or more and 8 parts by mass or less, relative to 100 parts by mass of the (A) component. When the amount of the latent epoxy curing agent (dicyandiamide) that is used is within the range described above, the curable epoxy resin composition can be sufficiently cured, and a cured product thereof has favorable adhesion.

On the other hand, in one or more embodiments of the present invention, when the curable epoxy resin composition is used as a two-component-type composition or multicomponent-type composition, amine-based curing agents (including imine-based curing agents) other than those mentioned above and a mercaptan-based curing agent (also referred to as a “room temperature curable curing agent”) can be selected as a (D) component that exhibits activity at a relatively low temperature around room temperature.

Examples of such a (D) component that exhibits activity at a relatively low temperature include chain aliphatic polyamines such as diethylenetriamine, triethylenetetramine, tetraethylenepentamine, dipropylenediamine, diethylaminopropylamine, and hexamethylenediamine; cyclic aliphatic polyamines such as N-aminoethylpiperazine, bis(4-amino-3-methylcyclohexyl)methane, menthanediamine, isophoronediamine, 4,4′-diaminodicyclohexylmethane, 3,9-bis(3-aminopropyl)-2,4,8,10-tetraoxaspiro[5.5]undecane (spiroacetaldiamine), norbornanediamine, tricyclodecanediamine, and 1,3-bisaminomethylcyclohexane; aliphatic-aromatic amines such as m-xylenediamine; polyamine-epoxy resin adducts, which are products of reactions between an epoxy resin and an excessive amount of polyamine; ketimines, which are products of dehydration reactions between a polyamine and a ketone such as methyl ethyl ketone or isobutyl methyl ketone; polyamideamines produced through condensation between a dimer (dimer acid) of tall oil fatty acid and a polyamine; amideamines produced through condensation between tall oil fatty acid and a polyamine; and polymercaptans.

Amine-terminated polyethers that include a polyether main chain and may include 1 or more and 4 or less (or 1.5 or more and 3 or less) amino groups and/or imino groups on average per molecule can also be used as the (D) component.

Furthermore, amine-terminated rubber that includes a conjugated diene-based polymer main chain and may include 1 or more and 4 or less (or 1.5 or more and 3 or less) amino groups and/or imino groups on average per molecule can also be used as the (D) component. Here, the main chain of the rubber may be a homopolymer or copolymer of polybutadiene, a polybutadiene/acrylonitrile copolymer, or a polybutadiene/acrylonitrile copolymer that contains an acrylonitrile monomer in an amount of 5 mass % or more and 40 mass % or less (10 mass % or more and 35 mass % or less, or 15 mass % or more and 30 mass % or less). An example of commercially available amine-terminated rubber is “Hypro 1300X16 ATBN” manufactured by CVC.

Among the above-mentioned amine-based curing agents that exhibit activity at a relatively low temperature around room temperature, polyamideamines, amine-terminated polyethers, and amine-terminated rubber are preferable, and it is particularly preferable to use a polyamideamine, an amine-terminated polyether, and amine-terminated rubber in combination.

Acid anhydrides, phenols, and the like can also be used as the (D) component. Acid anhydrides, phenols, and the like require higher temperatures compared with amine-based curing agents, but have along pot life. Furthermore, resultant cured products favorably balance the physical properties such as electrical properties, chemical properties, and mechanical properties. Examples of the acid anhydrides include polysebacic acid polyanhydride, polyazelaic acid polyanhydride, succinic anhydride, citraconic anhydride, itaconic anhydride, alkenyl-substituted succinic anhydride, dodecenylsuccinic anhydride, maleic anhydride, tricarballylic anhydride, methyl acid anhydride, linoleic adduct with maleic anhydride, alkyl-terminated alkylenetetrahydrophthalic anhydride, methyltetrahydrophthalic anhydride, tetrahydrophthalic anhydride, hexahydrophthalic anhydride, pyromellitic dianhydride, trimellitic anhydride, phthalic anhydride, tetrachlorophthalic anhydride, tetrabromophthalic anhydride, dichloromaleic anhydride, chloro acid anhydride, chlorendic anhydride, and maleic anhydride-grafted polybutadiene. Examples of the phenols include phenol novolak, bisphenol A novolak, and cresol novolak. The (D) components may be used alone or in combination of two or more.

The (D) component is used in an amount that is sufficient enough to cure the curable epoxy resin composition. Typically, a curing agent in an amount that is sufficient enough to consume at least 80% of the epoxide group present in the curable epoxy resin composition is supplied. In general, a large excess amount of the curing agent that excesses the amount required to consume the epoxide group is not needed. The amount of the (D) component that is used may be 1 part by mass or more and 80 parts by mass or less, 2 parts by mass or more and 40 parts by mass or less, 3 parts by mass or more and 30 parts by mass or less, or 5 parts by mass or more and 20 parts by mass or less, relative to 100 parts by mass of the (A) component. When the amount of the (D) component that is used is within the range described above, the curable epoxy resin composition has favorable curability, favorable storage stability, and improved handleability.

Curing Accelerator (E)

In one or more embodiments of the present invention, the curable epoxy resin composition may contain a curing accelerator (E) as needed. The (E) component is a catalyst for accelerating the reaction of an epoxy group with an epoxide reactive group on an epoxy curing agent and other components of the curable epoxy resin composition.

Examples of the (E) component include ureas such as p-chlorophenyl-N,N-dimethyl urea (product name: Monuron), 3-phenyl-1,1-dimethyl urea (product name: Phenuron), 3,4-dichlorophenyl-N,N-dimethyl urea (product name: Diuron), N-(3-chloro-4-methylphenyl)-N′,N′-dimethyl urea (product name: Chlortoluron), and 1,1-dimethylphenyl urea (product name: Dyhard); tertiary amines such as benzyldimethylamine, 2,4,6-tris(dimethylaminomethyl)phenol, 2-(dimethylaminomethyl)phenol, 2,4,6-tris(dimethylaminomethyl)phenol embedded in a poly(p-vinylphenol) matrix, triethylenediamine, and N,N-dimethylpiperidine; imidazoles such as C1-C12 alkylene imidazole, N-arylimidazole, 2-methylimidazole, 2-ethyl-2-methylimidazole, N-butylimidazole, 1-cyanoethyl-2-undecylimidazolium trimellitate, and addition products between an epoxy resin and imidazole; and 6-caprolactam. The catalyst may be encapsulated or may be a latent catalyst that exhibits activity when heated.

It should be noted that tertiary amines and imidazoles can improve the curing speed, the physical properties (heat resistance) of a cured product, and the like when used together with an amine-based curing agent serving as the (D) component. The (E) components may be used alone or in combination of two or more.

The amount of the (E) component that is used may be 0.1 part by mass or more and 10 parts by mass or less, 0.2 part by mass or more and 5 parts by mass or less, 0.5 part by mass or more and 3 parts by mass or less, or 0.8 part by mass or more and 2 parts by mass or less, relative to 100 parts by mass of the (A) component. When the amount of the (E) component that is used is within the range described above, the curable epoxy resin composition has favorable curability, favorable storage stability, and improved handleability.

Inorganic Filler

In one or more embodiments of the present invention, the curable epoxy resin composition may contain an inorganic filler as needed.

Examples of the inorganic filler include silicic acid and/or silicates. Specific examples thereof include dry silica, wet silica, aluminum silicate, magnesium silicate, calcium silicate, wollastonite, and talc. The dry silica is also called fumed silica, and examples thereof include hydrophilic fumed silica that is not subjected to surface treatment, and hydrophobic fumed silica manufactured through chemical treatment of a silanol group moiety of hydrophilic fumed silica with silane or siloxane. Hydrophobic fumed silica is preferable from the viewpoint of the dispersibility in the (A) component.

Examples of the inorganic filler also include reinforcing fillers such as dolomite and carbon black, colloidal calcium carbonate, heavy calcium carbonate, magnesium carbonate, titanium oxide, ferric oxide, minute aluminum powder, zinc oxide, and active zinc oxide. It is preferable that the inorganic filler is subjected to surface treatment with a surface treating agent. Surface treatment improves the dispersibility of the inorganic filler in the composition, which results in an improvement in the various physical properties of a cured product of the curable epoxy resin.

The amount of the inorganic filler that is used may be 1 part by mass or more and 100 parts by mass or less, 2 parts by mass or more and 70 parts by mass or less, 5 parts by mass or more and 40 parts by mass or less, or 7 parts by mass or more and 20 parts by mass or less, relative to 100 parts by mass of the (A) component. The inorganic fillers may be used alone or in combination of two or more.

Calcium Oxide

In one or more embodiments of the present invention, the curable epoxy resin composition may contain calcium oxide. Calcium oxide reacts with water in the curable epoxy resin composition and removes the water, and is thus useful to solve various issues in the physical properties posed by the presence of water. For example, calcium oxide functions as an agent that removes water and thus prevents air bubbles, and suppresses a decrease in adhesive strength.

Calcium oxide can be subjected to surface treatment with a surface treating agent. The surface treatment improves the dispersibility of the calcium oxide in the curable epoxy resin composition. As a result, compared with the case where calcium oxide that is not subjected to surface treatment is used, a cured product of the curable epoxy resin composition has improved physical properties such as adhesive strength. In particular, the T-peel adhesion and the impact peel-resistant adhesion are significantly improved. The surface treating agent is not particularly limited but may be a fatty acid.

The amount of calcium oxide that is used may be 0.1 part by mass or more and 10 parts by mass or less, 0.2 part by mass or more and 5 parts by mass or less, 0.5 part by mass or more and 3 parts by mass or less, or 1 part by mass or more and 2 parts by mass or less, relative to 100 parts by mass of the (A) component. When the amount of calcium oxide that is used is within the range described above, an effect of removing water is exhibited, and the strength of a cured product of the curable epoxy resin composition is not reduced. One type of calcium oxide may be used alone, or two or more types of calcium oxides may be used in combination.

Radical Curable Resin

In one or more embodiments of the present invention, radical curable resins having two or more double bonds in their molecules can be used as needed. Also, low-molecular-weight compounds that have a molecular weight of less than 300 and have at least one double bond in its molecule can be used as needed. When used together with the radical curable resins, the low-molecular-weight compounds have a function of adjusting the viscosity, the physical properties of a cured product, and the curing speed, and function as the so-called reactive diluent for the radical curable resins. Furthermore, in one or more embodiments of the present invention, a radical polymerization initiator can be added to the curable epoxy resin composition. Here, the radical polymerization initiator may be a latent one that is activated when heated (such as to a temperature of about 50° C. or higher and about 150° C. or lower).

Examples of the radical curable resin include unsaturated polyester resins, polyester (meth)acrylates, epoxy (meth)acrylates, urethane (meth)acrylates, polyether (meth)acrylates, and acrylic (meth)acrylates. These compounds may be used alone or in combination of two or more. Specific examples of the radial curable resin include compounds disclosed in WO 2014/115778 A1. Specific examples of the low-molecular-weight compounds and the radical polymerization initiators include compounds disclosed in WO 2014/1115778 A1.

If the radical polymerization initiator is activated at a temperature different from the curing temperature of the epoxy resin as disclosed in WO 2010/019539 A1, the curable epoxy resin composition can be partially cured through selective polymerization of the radical curable resin. This partial curing improves the viscosity of the curable epoxy resin composition after the curable epoxy resin composition has been applied, thus making it possible to improve the wash-off resistance thereof. It should be noted that, in a water washing shower step performed in a manufacturing line of vehicles or the like, there are cases where an uncured adhesive composition is partially dissolved, scattered, or deformed due to the pressure of shower water during the water washing shower step and the corrosion resistance of a portion of a steel plate to which the adhesive composition has been applied is adversely affected or the rigidity of the steel plate is reduced. The term “wash-off resistance” means the resistance against such issues. Also, this partial curing can impart a function of temporarily fixing (temporarily bonding) substrates to each other until the curing of a cured product is finished. In this case, a free radical polymerization initiator may be activated through heating to a temperature of 80° or higher or 130° C. or lower, or to a temperature of 100° C. or higher or 120° C. or lower.

Monoepoxide

In one or more embodiments of the present invention, a monoepoxide can be used as needed. The monoepoxide can serve as a reactive diluent. Specific examples of the monoepoxide include aliphatic glycidyl ethers such as butylglycidyl ether, aromatic glycidyl ethers such as phenylglycidyl ether and cresylglycidyl ether, ethers including an alkyl group having 8 to 10 carbon atoms and a glycidyl group such as 2-ethylhexylglycidyl ether, ethers including a phenyl group having 6 to 12 carbon atoms that may be subjected to substitution using an alkyl group having 2 to 8 carbon atoms and a glycidyl group, such as p-tert-butylphenylglycidyl ether, ethers including an alkyl group having 12 to 14 carbon atoms and a glycidyl group such as dodecylglycidyl ether; aliphatic glycidyl esters such as glycidyl (meth)acrylate and glycidyl maleate; glycidyl esters of aliphatic carboxylic acid having 8 to 12 carbon atoms such as glycidyl versatate, glycidyl neodecanoate, and glycidyl laurate; and glycidyl p-t-butylbenzoate.

The amount of the monoepoxide that is used may be 20 parts by mass or less, 0.1 part by mass or more and 20 parts by mass or less, 0.5 part by mass or more and 10 parts by mass or less, or 1 part by mass or more and 5 parts by mass or less, relative to 100 parts by mass of the (A) component. When the amount of the monoepoxide that is used is within the range described above, the viscosity of the curable epoxy resin composition can be reduced at a low temperature such as a temperature around ordinary temperature.

Photopolymerization Initiator

In one or more embodiments of the present invention, if the curable epoxy resin composition is cured through photo-curing, a photopolymerization initiator may be added thereto. Examples of the photopolymerization initiator include cationic photopolymerization initiators (photo-acid-generating agent) such as onium salts (e.g., aromatic sulfonium salts and aromatic iodonium salts), aromatic diazonium salts, and metallocene salts that are formed with anions such as hexafluoroantimonate, hexafluorophosphate, and tetraphenylborate. These photopolymerization initiators may be used alone or in combination of two or more.

Other Blend Components

In one or more embodiments of the present invention, other blend components can be used as needed. Examples of the other blend components include inflating agents such as azo-type chemical foaming agents and thermally inflatable microballoons, fiber pulp such as aramid-based pulp, coloring agents such as pigments and dyes, extender pigments, ultraviolet absorbers, antioxidants, stabilizers (anti-gelling agents), plasticizers, leveling agents, anti-foaming agents, silane coupling agents, anti-static agents, flame retardants, lubricants, viscosity reducing agents, shrinkage reducing agents, organic fillers, thermoplastic resins, drying agents, and dispersants.

In one or more embodiments of the present invention, when initial lap shear strength measured in accordance with JIS K 6850 before the curable epoxy resin composition is left to stand in an environment of saturated water vapor at 40° C. is taken as F1, and lap shear strength after moisture absorption test measured in accordance with JIS K 6850 after the curable epoxy resin composition is left to stand for 3 days in the environment of saturated water vapor at 40° C. is taken as F2, a ratio between F1 and F2 (F2/F1) may be 0.5 or more, 0.6 or more, or 0.7 or more. When the ratio between F1 and F2 is within the range described above, a change in the physical properties due to moisture absorption is significantly small, and the resistance to foaming by moisture absorption is excellent.

In one or more embodiments of the present invention, when the viscosity value at a shear speed of 5 s⁻¹ and 50° C. is taken as 150, and the viscosity value at a shear speed of 5 s⁻¹ and 100° C. is taken as η100, the curable epoxy resin composition may have a ratio between η50 and η100 (η100/η50) of 2.3 or more, 3 or more, 4 or more, or 5 or more. When the ratio between η50 and η100 is within the range described above, the viscosity is significantly increased at a high temperature of 100° C. or higher, and foaming caused by absorbed moisture can be suppressed more effectively.

Method for Manufacturing Curable Epoxy Resin Composition

In one or more embodiments of the present invention, the curable epoxy resin composition may be a composition obtained by dispersing the polymer having a core-shell structure (B1) as primary particles in a curable epoxy resin composition containing the epoxy resin (A) and the toughening agent (B).

Various methods can be used as a method for obtaining a curable epoxy resin composition in which the polymer having a core-shell structure (B1) is dispersed as primary particles, and examples thereof include a method in which the polymer having a core-shell structure (B1) obtained as an aqueous latex is brought into contact with the (A) component and then unnecessary components such as water are removed, and a method in which the polymer having a core-shell structure (B1) that is once extracted into an organic solvent is mixed with the (A) component and then the organic solvent is removed. It is preferable to use the method disclosed in WO 2005/028546 A1. Specifically, it is preferable that the manufacturing method includes a first step in which an aqueous latex containing the polymer having a core-shell structure (B1) (specifically a reaction mixture obtained after minute polymer particles have been manufactured through emulsion polymerization) is mixed with an organic solvent having a water solubility of 5 mass % or more and 40 mass % or less at 20° C. and then with an excessive amount of water to cause the minute particles of the polymer having a core-shell structure (B1) to aggregate; a second step in which the aggregate of the polymer having a core-shell structure (B1) is separated and collected from the liquid phase and is then mixed with an organic solvent again to obtain a solution of the polymer having a core-shell structure (B1) in the organic solvent; and a third step in which the organic solvent solution is further mixed with the (A) component and then the organic solvent is removed by distillation, and these steps are performed in the stated order.

It is preferable that the (A) component is in the form of a liquid at 23° C. because the third step can be easily performed. The term “in the form of a liquid at 23° C.” means that a substance has a softening point lower than 23° C. and exhibits fluidity at 23° C.

A predetermined curable epoxy resin composition in which the polymer having a core-shell structure (B1) is dispersed as primary particles is obtained by additionally mixing, as needed, the components including the (A) component, the (B2) component, the (B3) component, the (B4) component, the (B5) component, the (C) component, the (D) component, the (E) component, the inorganic filler, calcium oxide, the radical curable resin, the monoepoxide, the photopolymerization initiator, and the blend components into the composition obtained through the steps in which the polymer having a core-shell structure (B1) is dispersed in the (A) component as primary particles.

On the other hand, the polymer having a core-shell structure (B1) that is solidified using a salting-out method or the like and is then dried into the form of a powder can be dispersed in the (A) component using a disperser having a high mechanical shearing force such as a triple paint roll, a triple roll mill, or a kneader. At this time, the (B1) component can be efficiently dispersed by applying mechanical shearing force to the (A) component and the (B1) component at a high temperature. The dispersion temperature may be 50° C. or higher and 200° C. or lower, 70° C. or higher and 170° C. or lower, 80° C. or higher and 150° C. or lower, or 90° C. or higher and 120° C. or lower. When the dispersion temperature is within the range described above, favorable dispersibility is obtained, and the (A) component and the (B1) component are not deteriorated by heat.

In one or more embodiments of the present invention, when all of the blend components are blended in advance and are then hermetically stored, the curable epoxy resin composition can be used as a one-component curable epoxy resin composition that is cured through post-application heating or light irradiation. In one or more embodiments of the present invention, a configuration can be employed in which the curable epoxy resin composition is produced as a two-solution-type or multi-solution-type curable epoxy resin composition including: an A solution containing the (A) component as the main component and the (B) component and/or the (C) component; and a B solution that is separately produced and contains the (D) component and the (E) component and optionally the (B) component and/or the (C) component, and the A solution and the B solution are mixed before use. It is sufficient that the (B) component and/or the (C) component are contained in at least one of the A solution and the B solution. For example, the (B) component and/or the (C) component may be contained in only the A solution, or in only the B solution, or in both the A solution and the B solution. In one or more embodiments of the present invention, a curable epoxy resin composition used as a one-component curable epoxy resin composition is particularly beneficial from the viewpoint of excellent storage stability and handleability.

In one or more embodiments of the present invention, the curable epoxy resin composition may be used for structural adhesives such as structural adhesives for vehicles and aircraft and structural adhesives for wind power generation; paints; laminate materials to be used with glass fibers; materials for a printed-circuit board; solder resist; interlayer dielectric films; buildup materials; adhesives for an FPC; electrical insulating materials such as sealing materials for electronic components such as semiconductors and LEDs; semiconductor packaging materials such as die bond materials, underfill, anisotropically conductive film (ACF), anisotropically conductive pastes (ACP), non-conductive films (NCF), and non-conductive pastes (NCP); and sealing materials for display devices and lighting devices such as liquid crystal panels, OLED lights, and OLED displays. In particular, the curable epoxy resin composition is useful as a structural adhesive for vehicles.

Laminate

In a laminate of one or more embodiments of the present invention, a plurality of substrates are joined via a cured product of the curable epoxy resin composition.

Substrate

There is no particular limitation on the substrate, and examples thereof include those made of wood, metal, plastic, and glass. Examples of the metal include steel materials such as cold-rolled steel and molten zinc plated steel, and aluminum materials such as aluminum and coated aluminum. Examples of the plastic include various types of plastic such as general-purpose plastic, engineering plastic, and composite materials such as CFRP and GFRP. The substrate may be an automobile component. The automobile component may be an automobile frame or an automobile component other than an automobile frame. Automobile frames may be joined together via a cured product of the curable epoxy resin composition, and an automobile frame and another automobile component may be joined together via a cured product of the curable epoxy resin composition. The curable epoxy resin composition has excellent toughness and can thus be used to join different types of substrates having different linear expansion coefficients. Also, the curable epoxy resin composition can be used to join aerospace structural members, particularly exterior metal structural members.

The laminate obtained by joining two or more substrates is formed by bonding the substrates together with the curable epoxy resin composition being placed therebetween and then curing the curable epoxy resin composition, and exhibits high adhesive strength. In the case of a curable epoxy resin composition in which the polymer having a core-shell structure (B1) is dispersed as primary particles, a cured product in which the polymer having a core-shell structure (B1) is uniformly dispersed can be easily formed by curing the curable epoxy resin composition.

The curable epoxy resin composition can be applied using a desired method. The curable epoxy resin composition can be applied at a low temperature around room temperature, and can also be heated to a temperature of about 50° C. as needed, for example, before being applied. The curable epoxy resin composition can be extruded, on the substrate, in abead shape, monofilament shape, or swirl shape using an application robot, and a mechanical application method using a calking gun and other manual application means can also be used. Also, the curable epoxy resin composition can be applied to the substrate using a jet-spray method or a streaming method. The curable epoxy resin composition is applied to one or two substrates, and the substrates are attached to each other such that the curable epoxy resin composition is arranged between the substrates to be joined, and are joined together by curing the curable epoxy resin composition. Since the curable epoxy resin composition has excellent resistance to foaming by moisture absorption, a laminate having high adhesive strength can be obtained even when the curable epoxy resin composition is applied to a plurality of substrates and is cured after being left to stand for a predetermined period of time.

The viscosity of the curable epoxy resin composition is not particularly limited, and may be about 150 Pa s or more and 600 Pa s or less at 45° C. for an extruding bead method, about 100 Pa s at 45° C. for a swirl application method, or about 20 Pa s or more and 400 Pa s or less at 45° C. for a high volume application method using a high-speed fluidizing device.

Curing

The curing temperature of the curable epoxy resin composition is not particularly limited, and may be 80° C. or higher and 250° C. or lower, 100° C. or higher and 220° C. or lower, 110° C. or higher and 200° C. or lower, or 130° C. or higher and 180° C. or lower when the curable epoxy resin composition is used as a one-component curable epoxy resin composition.

When the curable epoxy resin composition is used as a structural adhesive for vehicles such as automobiles, it is preferable to apply the adhesive to an automobile substrate, then apply a coating agent thereto, and performing baking and curing of the coating agent and curing of the adhesive at the same time from the viewpoint of shortening and simplifying the steps.

### EXAMPLES

Hereinafter, one or more embodiments of the present invention will be described more specifically based on examples and comparative examples. However, the embodiments of the present invention is not limited to only these examples, and modifications can be made as appropriate as long as they are in conformity with the gist mentioned above and below, and all of these modifications are encompassed within the technical scope of the embodiments of the present invention.

First, various measurement methods and evaluation methods will be described.

Measurement of Volume Average Particle Diameters of Particles of Butadiene Rubber and Particles of Polymer Having Core-Shell Structure in Latices

The volume average particle diameters of particles of polybutadiene rubber in a polybutadiene rubber latex and particles of the polymer having a core-shell structure in a latex of the polymer having a core-shell structure were measured using Microtrac UPA150 (manufactured by Nikkiso Co., Ltd.).

Solutions obtained by diluting the latices with deionized water were used as measurement samples. The measurement was performed after the refractive index of water or methyl ethyl ketone and the refractive index of each polymer having a core-shell structure had been input, the measurement time had been set to 600 seconds, and the sample concentration had been adjusted such that Signal level was within a range of 0.6 to 0.8.

Measurement of Molecular Weight

The molecular weight was measured using HLC-82201 manufactured by Tosoh Corporation as the system, TSKgel SuperHZM-H (two columns) manufactured by Tosoh Corporation as the columns, and THE as the solvent, and was represented as a polystyrene converted weight average molecular weight.

Methyl Ethyl Ketone Soluble Matter

After 1 g of the carboxyl group-containing non-cross-linked acrylic resin (C) had been dissolved in 50 g of methyl ethyl ketone (MEK), the resultant solution was centrifuged at 10° C. and 30,000 rpm for 3 hours using a centrifuge (“Ultracentrifuge CP80NX” manufactured by HITACHI). After separated MEK soluble matter was removed by decantation, MEK insoluble matter was dried at 60° C. for 10 hours using a vacuum dryer, and the mass (g) thereof was measured. The amount (mass %) of MEK soluble matter was calculated based on the following formula.

MEK soluble matter(mass %)=(1−mass of MEK insoluble matter)×100

Glass-Transition Temperature

The glass-transition temperature (Tg) was measured as follows using a differential scanning calorimeter “DSC7020” manufactured by Hitachi High-Tech Science Corporation: after preliminary adjustment was performed in which a sample was once heated to 200° C. at a rate of 25° C./minute, was kept at the same temperature for 10 minutes, and was cooled to 25° C. at a rate of 25° C./minute, a measurement was performed while the sample was heated to 200° C. at a rate of 5° C./minute, and then the glass-transition temperature was determined based on the method described in JIS K 7121 (Testing Methods for Transition Temperatures of Plastics: IS03146).

Content of Carboxyl Group

The content of a carboxyl group in the carboxyl group-containing non-cross-linked acrylic resin was calculated based on the amount of the monomer that had been prepared for manufacturing.

In addition, the content of a carboxyl group in the carboxyl group-containing non-cross-linked acrylic resin can also be measured and calculated using the following method.

After about 1 g of the acrylic resin including a carboxyl group has been precisely weighed to four places of decimals and dissolved in 50 mL of a solvent (ion-exchanged water/acetonitrile=50/50 vol %), the pH of the resultant solution is set to 2.5 or less using a 0.1 mol/L hydrochloric acid solution. This solution is subjected to potentiometric titration with a 0.1 mol/L potassium hydroxide solution using an automatic titrator, and the inflection point of the obtained titration curve is taken as the end point. The acid value is calculated in accordance with JIS K 0070 and is then used to calculate the content of a carboxyl group in the carboxyl group-containing acrylic resin.

Epoxy Equivalent

The epoxy equivalent of the epoxy resin (A) was measured in accordance with JIS K 7236.

Measurement of Viscosity of Curable Epoxy Resin Composition

The average value of the viscosity of the curable epoxy resin composition measured using a rheometer for 1 minute at a shear rate of 5 s⁻¹ after being kept at 50° C. for 4 minutes was taken as η50, the average value of the viscosity of the curable epoxy resin composition measured using a rheometer for 1 minute at a shear rate of 5 s⁻¹ after being kept at 100° C. for 4 minutes was taken as η100, and a ratio of η100 to η50 (η100/η50) was used to evaluate the viscosity at a high temperature of 100° C. or higher. The greater 4100/50, the higher the viscosity of the curable epoxy resin composition at a high temperature of 100° C. or higher, and the higher the resistance to foaming by moisture absorption.

The viscosity was measured using “Bohlin CVO rheometer” manufactured by Malvern under the condition that PP25 was used and the gap between the plates was set to 0.2 mm, and “Pa s” was used as the unit thereof.

Initial Shear Adhesive Strength

The initial shear adhesive strength was evaluated in accordance with JIS K 6850. A test piece was produced by applying the curable epoxy resin composition to two SPCC steel plates having a width of 25 mm, a length of 100 mm, and a thickness of 1.6 mm, attaching the two SPCC steel plates to each other such that the adhesive layer had a width of 25 mm, a length of 12.5 mm, and a thickness of 0.26 mm, and curing the curable epoxy resin composition at 170° C. for 1 hour. The initial shear adhesive strength (F1) was measured under the condition that the measurement temperature was set to 23° C. and the testing speed was set to 1.3 mm/min, and “MPa” was used as the unit thereof.

Post-Moisture-Absorption Shear Adhesive Strength

The post-moisture-absorption shear adhesive strength was evaluated in accordance with JIS K 6850. Atest piece was produced by applying the curable epoxy resin composition to predetermined positions of two SPCC steel plates having a width of 25 mm, a length of 100 mm, and a thickness of 1.6 mm such that the curable epoxy resin layer having a width of 25 mm, a length of 12.5 mm, and a thickness of 0.3 mm, leaving the curable epoxy resin composition to stand for 3 days under the environment at 40° C. in saturated water vapor, attaching the two SPCC steel plates to each other such that the adhesive layer had a width of 25 mm, a length of 12.5 mm, and a thickness of 0.26 mm, and curing the curable epoxy resin composition at 170° C. for 1 hour. The post-moisture-absorption shear adhesive strength (F2) was measured under the condition that the measurement temperature was set to 23° C. and the testing speed was set to 1.3 mm/min, and “MPa” was used as the unit thereof.

The larger the ratio of the post-moisture-absorption shear adhesive strength (F2) to the initial shear adhesive strength (F1) (F2/F1), the higher the effect of suppressing moisture absorption-induced foaming.

Manufacturing Examples of Polymer Having Core-Shell Structure (B1), and Manufacturing Examples of Epoxy Resin (N) in Which Polymer Having Core-Shell Structure (B1) is Dispersed

Methods for producing polybutadiene rubber latices (R-1) and (R-2) containing polybutadiene rubber to be included in the core layer of a polymer having a core-shell structure (B1-1) are described in Manufacturing Example 1-1 and Manufacturing Example 1-2, respectively. Alatex of the polymer having a core-shell structure (B-1) (L-1) is described in Manufacturing Example 2-1. An epoxy resin (N-1) in which the polymer having a core-shell structure (B1-1) is dispersed is described in Manufacturing Example 3-1.

### Manufacturing Example 1-1: Manufacturing of Polybutadiene Rubber Latex (R-1)

After 200 parts by mass of deionized water, 0.03 part by mass of tripotassium phosphate, 0.002 part by mass of disodium ethylenediaminetetraacetate (EDTA), 0.001 part by mass of ferrous sulfate heptahydrate, and 1.55 parts by mass of sodium dodecylbenzenesulfonate (SDBS) were fed into a pressure-resistant polymerizing machine, and oxygen was sufficiently removed therefrom through nitrogen purging while the resultant mixture was stirred, 100 parts by mass of butadiene (Bd) was fed into the pressure-resistant polymerizing machine, and the mixture was heated to 45° C. Then, 0.03 part by mass of p-menthane hydroperoxide (PHP) and 0.10 part by mass of sodium formaldehydesulfoxylate (SFS) were fed thereinto in this order to start polymerization. Then, 0.025 part by mass of p-menthane hydroperoxide (PHP) was fed thereinto 3, 5, and 7 hours after the start of the polymerization. In addition, 0.0006 part by mass of EDTA and 0.003 part by mass of ferrous sulfate heptahydrate were fed thereinto 4, 6, and 8 hours after the start of the polymerization. The polymerization was finished 15 hours after the start thereof by devolatilizing the residual monomer under reduced pressure, and thus a polybutadiene rubber latex (R-1) containing polybutadiene rubber as a main component was obtained. The volume average particle diameter of polybutadiene rubber particles in the obtained latex was 0.08 μm.

### Manufacturing Example 1-2: Manufacturing of Polybutadiene Rubber Latex (R-2)

After 21 parts by mass of the polybutadiene rubber latex (R-1) (containing 7 parts by mass of polybutadiene rubber) obtained in Manufacturing Example 1-1, 185 parts by mass of deionized water, 0.03 part by mass of tripotassium phosphate, 0.002 part by mass of EDTA, and 0.001 part by mass of ferrous sulfate heptahydrate were fed into a pressure-resistant polymerizing machine, and oxygen was sufficiently removed therefrom through nitrogen purging while the resultant mixture was stirred, 93 parts by mass of Bd was fed into the pressure-resistant polymerizing machine, and the mixture was heated to 45° C. Then, 0.02 part by mass of PHP and 0.10 part by mass of SFS were fed thereinto in this order to start polymerization. Then, 0.025 part by mass of PHP, 0.0006 part by mass of EDTA, and 0.003 part by mass of ferrous sulfate heptahydrate were fed thereinto every 3 hours for 24 hours after the start of the polymerization. The polymerization was finished 30 hours after the start thereof by devolatilizing the residual monomer under reduced pressure, and thus a polybutadiene rubber latex (R-2) containing polybutadiene rubber as a main component was obtained. The volume average particle diameter of polybutadiene rubber particles contained in the obtained latex was 0.20 μm.

### Manufacturing Example 2-1: Manufacturing of Latex (L-1) of Polymer Having Core-Shell Structure (B1-1)

First, 262 parts by mass of the polybutadiene rubber latex (R-2) containing 87 parts by mass of polybutadiene rubber particles, which had been produced in Manufacturing Example 1-2, and 59 parts by mass of deionized water were fed into a glass reactor equipped with a thermometer, a stirrer, a reflux condenser, a nitrogen inlet, and a monomer addition device, and the resultant mixture was stirred at 60° C. with nitrogen purging being performed. Next, graft polymerization was performed by adding 0.005 part by mass of EDTA, 0.001 part by mass of ferrous sulfate heptahydrate, and 0.2 part by mass of SFS thereto, and then adding a mixture of 13 parts by mass of a graft monomer for forming the shell layer (5.5 parts by mass of styrene, 1.5 parts by mass of methyl methacrylate, 2.5 parts by mass of acrylonitrile, and 3.5 parts by mass of glycidyl methacrylate) and 0.035 part by mass of cumene hydroperoxide thereto continuously over 1.3 hours. After the addition was finished, the mixture was stirred for another 2 hours and then the reaction was finished. A latex (L-1) of the polymer having a core-shell structure (B1-1) was thus obtained. The volume average particle diameter of the particles of the polymer having a core-shell structure (B1-1) contained in the obtained latex was 0.21 μm.

### Manufacturing Example 3-1: Manufacturing of Epoxy Resin (N-1) in Which Polymer Having Core-Shell Structure (B1-1) is Dispersed

First, 132 g of methyl ethyl ketone was introduced into a 1-L mixing tank at 25° C., and then 132 g of the latex (L-1) of the polymer having a core-shell structure (n1-1) containing 40 g of the polymer having a core-shell structure (B1-1), which had been obtained in Manufacturing Example 2-1, was fed thereinto with methyl ethyl ketone being stirred. After the mixture was uniformly mixed, 200 g of water was fed thereinto at a supply speed of 80 g/minute. When stirring was stopped immediately after water had been supplied, a slurry solution constituted by a buoyant aggregate and an aqueous phase containing the organic solvent as portions thereof was obtained. Next, 360 g of the aqueous phase was discharged through an outlet provided to the lower portion of the tank, and thus the aggregate containing a portion of the aqueous phase was left. Then, 90 g of methyl ethyl ketone was added to the obtained aggregate and uniformly mixed, and thus a solution in which the polymer having a core-shell structure (B1-1) was dispersed was obtained. Next, 60 g of an epoxy resin (A-1: JER828EL manufactured by Mitsubishi Chemical Corporation) serving as the (A) component was mixed into this solution, and volatile matter was removed using a rotation evaporator. Thus, an epoxy resin (N-1) in which the particles of the polymer having a core-shell structure (B1-1) are dispersed was obtained. The epoxy resin in which the core-shell graft polymer particles were dispersed (N-1) contained the polymer having a core-shell structure (B1-1) in an amount of 40 mass %.

### Manufacturing Examples of Carboxyl Group-Containing Non-Cross-Linked Acrylic Resin(C)

### Manufacturing Example 4-1: Manufacturing of Non-Cross-Linked Acrylic Resin Including Carboxyl Group (C-1)

First, 350 g of deionized water and 0.02 g of sodium diisooctylsulfosuccinate was fed into a 2-liter polymerizing apparatus equipped with a stirrer, a reflux condenser, a thermometer, a nitrogen gas introducing pipe, and a feed pump, and the resultant mixture was heated to 90° C. while being stirred in a nitrogen atmosphere. After 5.2 g of an aqueous solution containing sodium persulfate in an amount of 5 mass % and 4.5 g of an aqueous solution containing sodium pyrosulfite in an amount of 5 mass % were added thereto, a monomer emulsion produced by mixing and stirring 540 g of methyl methacrylate (MMA), 10 g of itaconic acid, 5.0 g of sodium diisooctylsulfosuccinate, and 180 g of deionized water was dropped thereinto over 75 minutes. Thereafter, stirring was continued at 85° C. for 1 hour, and thus a latex was obtained. The obtained latex was cooled to room temperature and was then subjected to spray drying using a spray dryer (“L-12-LS type” manufactured by Ohkawara Kakohki Co., Ltd.) under the condition that the inlet temperature was set to 130° C., the outlet temperature was set to 60° C., and the rotation speed of an atomizer disk was set to 20000 rpm. Thus, a carboxyl group-containing non-cross-linked acrylic resin (C-1) was manufactured. The weight average molecular weight of the carboxyl group-containing non-cross-linked acrylic resin (C-1) was 850,000, the content of a carboxyl group was 0.28 mmol/g, the glass-transition temperature was 120° C., and the amount of MEK soluble matter was 99 mass %.

### Manufacturing Example 4-2: Manufacturing of Carboxyl Group-Containing Non-Cross-Linked Acrylic Resin(C-2)

A carboxyl group-containing non-cross-linked acrylic resin (C-2) was manufactured using the same method as in Manufacturing Example 4-1, except that the amount of the aqueous solution containing sodium persulfate in an amount of 5 mass % was changed to 11.0 g, the amount of the aqueous solution containing sodium pyrosulfite in an amount of 5 mass % was changed to 9.4 g, the amount of methyl methacrylate (MMA) was changed to 547.3 g, and the amount of itaconic acid was changed to 2.7 g. The weight average molecular weight of the carboxyl group-containing non-cross-linked acrylic resin (C-2) was 430,000, the content of a carboxyl group was 0.08 mmol/g, the glass-transition temperature was 112° C., and the amount of MEK soluble matter was 98.1 mass %.

### Manufacturing Example 4-3: Manufacturing of Carboxyl Group-Containing Non-Cross-Linked Acrylic Resin (C-3)

A carboxyl group-containing non-cross-linked acrylic resin (C-3) was manufactured using the same method as in Manufacturing Example 4-1, except that the amount of the aqueous solution containing sodium persulfate in an amount of 5 mass % was changed to 11.0 g, the amount of the aqueous solution containing sodium pyrosulfite in an amount of 5 mass % was changed to 9.4 g, the amounts of methyl methacrylate (MMA) and itaconic acid in the monomer emulsion were changed to 517 g and 11 g, respectively, and 22 g of methacrylic acid (MAA) was further added when the monomer emulsion was produced. The weight average molecular weight of the carboxyl group-containing non-cross-linked acrylic resin (C-3) was 340,000, the content of a carboxyl group was 0.77 mmol/g, the glass-transition temperature was 120° C., and the amount of MEK soluble matter was 97.2 mass %.

### Manufacturing Example 4-4: Manufacturing of Carboxyl Group-Containing Non-Cross-Linked Acrylic Resin (C-4)

A carboxyl group-containing non-cross-linked acrylic resin (C-4) was manufactured using the same method as in Manufacturing Example 4-1, except that the amount of the aqueous solution containing sodium persulfate in an amount of 5 mass % was changed to 11.0 g, the amount of the aqueous solution containing sodium pyrosulfite in an amount of 5 mass % was changed to 9.4 g, the amounts of methyl methacrylate (MMA) and itaconic acid in the monomer emulsion were changed to 506 g and 11 g, respectively, and 33 g of methacrylic acid (MAA) was further added when the monomer emulsion was produced. The weight average molecular weight of the carboxyl group-containing non-cross-linked acrylic resin (C-4) was 360,000, the content of a carboxyl group was 1.00 mmol/g, the glass-transition temperature was 127° C., and the amount of MEK soluble matter was 84.1 mass %.

### Manufacturing Example 4-5: Manufacturing of Carboxyl Group-Containing Non-Cross-Linked Acrylic Resin(C-5)

First, 530 g of deionized water, 2.8 g of sodium diisooctylsulfosuccinate, 0.52 g of sodium sulfate, and 0.2 g of sodium carbonate was fed into a 2-liter polymerizing apparatus equipped with a stirrer, a reflux condenser, a thermometer, a nitrogen gas introducing pipe, and a feed pump, and the resultant mixture was heated to 70° C. while being stirred in a nitrogen atmosphere. A monomer mixture including 330 g of methyl methacrylate (MMA), 50 g of butyl acrylate (BA), and 20 g of methacrylic acid (MAA) was dropped thereinto over 180 minutes. Moreover, 0.002 g of sodium persulfate was added 10 minutes and 60 minutes after the start of the addition of the monomer mixture, 0.016 g of sodium persulfate was added 120 minutes thereafter, and 0.4 g of sodium persulfate was added 150 minutes thereafter. After 180 minutes had elapsed, stirring was continued for another 60 minutes, and thus a latex was obtained. The obtained latex was cooled to room temperature and was then subjected to spray drying using a spray dryer (“L-12-LS type” manufactured by Ohkawara Kakohki Co., Ltd.) under the condition that the inlet temperature was set to 130° C., the outlet temperature was set to 60° C., and the rotation speed of an atomizer disk was set to 20000 rpm. Thus, a carboxyl group-containing non-cross-linked acrylic resin (C-5) was manufactured. The weight average molecular weight of the carboxyl group-containing non-cross-linked acrylic resin (C-5) was 5,100,000, the content of a carboxyl group was 0.58 mmol/g, the glass-transition temperature was 102° C., and the amount of MEK soluble matter was 63.4 mass %.

### Manufacturing Example 4-6: Manufacturing of Carboxyl Group-Containing Non-Cross-Linked Acrylic Resin (C-6)

A carboxyl group-containing non-cross-linked acrylic resin (C-6) was manufactured using the same method as in Manufacturing Example 4-5, but the amount of methyl methacrylate (MMA) was changed to 310 g, the amount of butyl acrylate (BA) was changed to 50 g, and the amount of methacrylic acid (MAA) was changed to 40 g. The weight average molecular weight of the carboxyl group-containing non-cross-linked acrylic resin (C-6) was 4,300,000, the content of a carboxyl group was 1.16 mmol/g, the glass-transition temperature was 100° C., and the amount of MEK soluble matter was 31.6 mass %.

### Manufacturing Example of Non-Cross-Linked Acrylic Resin Having No Carboxyl Group

### Manufacturing Example 4-7: Manufacturing of Non-Cross-Linked Acrylic Resin Having No Carboxyl Group (X-1)

A non-cross-linked acrylic resin having no carboxyl group (X-1) was manufactured using the same method as in Manufacturing Example 4-1, except that the amount of the aqueous solution containing sodium persulfate in an amount of 5 mass % was changed to 7.8 g, the amount of the aqueous solution containing sodium pyrosulfite in an amount of 5 mass % was changed to 6.8 g, the amount of methyl methacrylate (MMA) was changed to 550 g, and the amount of itaconic acid was changed to 0 g. The weight average molecular weight of the non-cross-linked acrylic resin having no carboxyl group (X-1) was 250,000, the glass-transition temperature was 116° C., and the amount of MEK soluble matter was 85.5 mass %.

The following shows the compounds used in the examples and the comparative examples.

(A) Epoxy Resin

(A-1) JER828EL (manufactured by Mitsubishi Chemical Corporation, bisphenol A-type epoxy resin, epoxy equivalent of 186 g/eq, liquid form at ordinary temperature)

(B) Toughening Agent

(B1-1) Polymer having a core-shell structure (B1-1) contained in latex (L-1) of polymer having a core-shell structure (B1-1) produced in Manufacturing Example 2-1

(B2-1): Blocked isocyanate including polypropylene glycol structure (blocked NCO equivalent of 220, viscosity of 30000 mPa s/25° C.), “Adekaresin QR-9466” manufactured by ADEKA

(C) Carboxyl Group-Containing Non-Cross-Linked Acrylic Resin

(C-1) to (C-6): Carboxyl Group-Containing Non-cross-linked acrylic resins (C-1) to (C-6) produced in Manufacturing Examples 4-1 to 4-6

(D) Epoxy Curing Agent

(D-1) Dyhard 100S (manufactured by AlzChem, dicyandiamide)

(E) Curing Accelerator

(E-1) Dyhard UR300 (manufactured by AlzChem, 1,1-dimethyl-3-phenyl urea)

(N-1): Epoxy resin (N-1) in which polymer having a core-shell structure (B1-1) produced in Manufacturing Example 3-1 is dispersed

(X-1): Non-cross-linked acrylic resin having no carboxyl group (X-1) produced in Manufacturing Example 4-7

(Y-1): Cross-linked acrylic resin (“ZEFIAC F351” manufactured by Ganz Chemical Co., Ltd.)

Heavy calcium carbonate: WHITON SB Red (manufactured by Shiraishi Calcium Kaisha, Ltd., untreated heavy calcium carbonate, average particle diameter: 1.8 μm)

Calcium Oxide: CML #31 (manufactured by Ohmi Chemical Industry Co., Ltd.)

Carbon black: MONARCH 280 (manufactured by Cabot)

Reactive diluent: Cardula E10P (manufactured by Momentive, glycidyl versatate)

### Examples 1 to 17, Comparative Examples 1 to 4

The above-described compounds were uniformly mixed with the mixing ratios shown in Table 1 and Table 2 below to produce curable epoxy resin compositions having the blend compositions shown in Table 1 and Table 2 below.

The viscosities η50 and η100 and the shear adhesive strengths F1 and F2 of the curable epoxy resin compositions obtained in the examples and the comparative examples were measured as described above. Table 1 and Table 2 below show the results. Table 1 and Table 2 below also show the values of the ratios (η100/η50) between viscosities before and after the temperature was increased and the values of the ratios (F2/F1) between shear adhesive strengths before and after moisture was absorbed.

TABLE 1

| | | | Examples | | | | | | | | | | |
|---|---|---|---|---|---|---|---|---|---|---|---|---|---|
| | | | 1 | 2 | 3 | 4 | 5 | 6 | 7 | 8 | 9 | 10 | 11 |
| Mixing | Epoxy resin (A-1) | Parts by mass | 55 | 55 | 55 | 70 | 100 | 100 | 55 | 55 | 55 | 55 | 55 |
| ratio | Epoxy resin (N-1) in which polymer | Parts by mass | 75 | 75 | 75 | 50 | — | — | 75 | 75 | 75 | 75 | 75 |
| | having a core-shell structure (B1-1) | | | | | | | | | | | | |
| | is dispersed | | | | | | | | | | | | |
| | (Core-shell polymer concentration: | | | | | | | | | | | | |
| | 40 mass %) | | | | | | | | | | | | |
| | Blocked isocyanate (B2-1) | Parts by mass | — | — | — | 10 | 30 | 30 | — | — | — | — | — |
| | Carboxyl group-containing non -cross- | Parts by mass | 10 | 5 | 20 | 10 | 10 | 20 | — | — | — | — | — |
| | linked acrylic resin (C-1) | | | | | | | | | | | | |
| | Carboxyl group-containing non -cross- | Parts by mass | — | — | — | — | — | — | 10 | — | — | 15 | — |
| | linked acrylic resin (C-2) | | | | | | | | | | | | |
| | Carboxyl group-containing non -cross- | Parts by mass | — | — | — | — | — | — | — | 10 | — | — | 15 |
| | linked acrylic resin (C-3) | | | | | | | | | | | | |
| | Carboxyl group-containing non -cross- | Parts by mass | — | — | — | — | — | — | — | — | 10 | — | — |
| | linked acrylic resin (C-4) | | | | | | | | | | | | |
| | Epoxy curing agent (D-1) | Parts by mass | 7 | 7 | 7 | 7 | 7 | 7 | 7 | 7 | 7 | 7 | 7 |
| | Curing accelerator (E-1) | Part by mass | 1 | 1 | 1 | 1 | 1 | 1 | 1 | 1 | 1 | 1 | 1 |
| | Reactive diluent | Parts by mass | 10 | 10 | 10 | 10 | 10 | 10 | 10 | 10 | 10 | 10 | 10 |
| | Carbon black | Part by mass | 0.3 | 0.3 | 0.3 | 0.3 | 0.3 | 0.3 | 0.3 | 0.3 | 0.3 | 0.3 | 0.3 |
| | Heavy calcium carbonate | Parts by mass | 15 | 15 | 15 | 15 | 15 | 15 | 15 | 15 | 15 | 15 | 15 |
| | Calcium oxide | Parts by mass | 1.5 | 1.5 | 1.5 | 1.5 | 1.5 | 1.5 | 1.5 | 1.5 | 1.5 | 1.5 | 1.5 |
| Blend | Epoxy resin (A-1) | Parts by mass | 100 | 100 | 100 | 100 | 100 | 100 | 100 | 100 | 100 | 100 | 100 |
| composition | Core-shell graft polymer (B1-1) | Parts by mass | 30 | 30 | 30 | 20 | — | — | 30 | 30 | 30 | 30 | 30 |
| | Blocked isocyanate (B2-1) | Parts by mass | — | — | — | 10 | 30 | 30 | — | — | — | — | — |
| | Carboxyl group-containing non -cross- | Parts by mass | 10 | 5 | 20 | 10 | 10 | 20 | — | — | — | — | — |
| | linked acrylic resin (C-1) | | | | | | | | | | | | |
| | Carboxyl group-containing non -cross- | Parts by mass | — | — | — | — | — | — | 10 | — | — | 15 | — |
| | linked acrylic resin(C-2) | | | | | | | | | | | | |
| | Carboxyl group-containing non -cross- | Parts by mass | — | — | — | — | — | — | — | 10 | — | — | 15 |
| | linked acrylic resin (C-3) | | | | | | | | | | | | |
| | Carboxyl group-containing non -cross- | Parts by mass | — | — | — | — | — | — | — | — | 10 | — | — |
| | linked acrylic resin (C-4) | | | | | | | | | | | | |
| | Epoxy curing agent (D-1) | Parts by mass | 7 | 7 | 7 | 7 | 7 | 7 | 7 | 7 | 7 | 7 | 7 |
| | Curing accelerator (E-1) | Part by mass | 1 | 1 | 1 | 1 | 1 | 1 | 1 | 1 | 1 | 1 | 1 |
| | Reactive diluent | Parts by mass | 10 | 10 | 10 | 10 | 10 | 10 | 10 | 10 | 10 | 10 | 10 |
| | Carbon black | Part by mass | 0.3 | 0.3 | 0.3 | 0.3 | 0.3 | 0.3 | 0.3 | 0.3 | 0.3 | 0.3 | 0.3 |
| | Heavy calcium carbonate | Parts by mass | 15 | 15 | 15 | 15 | 15 | 15 | 15 | 15 | 15 | 15 | 15 |
| | Calcium oxide | Parts by mass | 1.5 | 1.5 | 1.5 | 1.5 | 1.5 | 1.5 | 1.5 | 1.5 | 1.5 | 1.5 | 1.5 |
| Evaluation | Initial shear adhesive strength (F1) | MPa | 23.8 | 23.0 | 25.0 | 18.3 | 14.3 | 14.5 | 25.7 | 21.4 | 21.1 | 26.1 | 22.8 |
| | Post-moisture-absorption shear adhesive | MPa | 15.3 | 16.5 | 20.5 | 19.0 | 16.5 | 18.5 | 21.3 | 20.8 | 18.2 | 21.4 | 21.4 |
| | strength (F2) | | | | | | | | | | | | |
| | Shear adhesive strength ratio (F2/F1) | | 0.64 | 0.72 | 0.82 | 1.03 | 1.15 | 1.27 | 0.83 | 0.97 | 0.86 | 0.82 | 0.94 |
| | Viscosity at 50° C. (η150) | Pa · s | 19 | 9 | 32 | 8 | 5 | 10 | 12 | 12 | 13 | 14 | 15 |
| | Viscosity at 100° C. (η100) | Pa · s | 166 | 49 | 390 | 104 | 38 | 169 | 87 | 55 | 64 | 171 | 130 |

| | | | | | | | | | | | |
|---|---|---|---|---|---|---|---|---|---|---|---|
| Viscosity ratio (η100/η50) | 8.6 | 5.4 | 12.1 | 13.5 | 7.6 | 16.2 | 7.6 | 4.7 | 5.0 | 11.8 | 8.9 |

TABLE 2

| | | | Examples | | | | | | Comparative examples | | | |
|---|---|---|---|---|---|---|---|---|---|---|---|---|
| | | | 12 | 13 | 14 | 15 | 16 | 17 | 1 | 2 | 3 | 4 |
| Mixing | Epoxy resin (A-1) | Parts by mass | 55 | 55 | 55 | 55 | 70 | 70 | 55 | 55 | 55 | 55 |
| ratio | Epoxy resin (N-1) in which polymer having a | Parts by mass | 75 | 75 | 75 | 75 | 50 | 50 | 75 | 75 | 75 | 75 |
| | core-shell structure (B1-1) is dispersed | | | | | | | | | | | |
| | (Core-shell polymer concentration: 40 mass %) | | | | | | | | | | | |
| | Blocked isocyanate (B2-1) | Parts by mass | — | — | — | — | 10 | 10 | — | — | — | — |
| | Carboxyl group-containing non-cross-linked | Parts by mass | — | — | — | — | 10 | 15 | — | — | — | |
| | acrylic resin (C-2) | | | | | | | | | | | |
| | Carboxyl group-containing non-cross-linked | Parts by mass | 15 | — | — | — | — | — | — | — | — | — |
| | acrylic resin (C-4) | | | | | | | | | | | |
| | Carboxyl group-containing non-cross-linked | Parts by mass | | 15 | 20 | — | — | — | — | — | — | — |
| | acrylic resin (C-5) | | | | | | | | | | | |
| | Carboxyl group-containing non-cross-linked | Parts by mass | — | — | — | 20 | — | — | — | — | — | — |
| | acrylic resin (C-6) | | | | | | | | | | | |
| | Non-cross-linked acrylic resin having no | Parts by mass | — | — | — | — | — | — | — | 10 | 7.5 | — |
| | carboxyl group (X-1) | | | | | | | | | | | |
| | Cross-linked acrylic resin (Y-1) | Parts by mass | — | — | — | — | — | — | — | — | — | 10 |
| | Epoxy curing agent (D-1) | Parts by mass | 7 | 7 | 7 | 7 | 7 | 7 | 7 | 7 | 7 | 7 |
| | Curing accelerator (E- 1) | Part by mass | 1 | 1 | 1 | 1 | 1 | 1 | 1 | 1 | 1 | 1 |
| | Reactive diluent | Parts by mass | 10 | 10 | 10 | 10 | 10 | 10 | 10 | 10 | 10 | 10 |
| | Carbon black | Part by mass | 0.3 | 0.3 | 0.3 | 0.3 | 0.3 | 0.3 | 0.3 | 0.3 | 0.3 | 0.3 |
| | Heavy calcium carbonate | Parts by mass | 15 | 15 | 15 | 15 | 15 | 15 | 15 | 15 | 15 | 15 |
| | Calcium oxide | Parts by mass | 1.5 | 1.5 | 1.5 | 1.5 | 1.5 | 1.5 | 1.5 | 1.5 | 1.5 | 1.5 |
| Blend | Epoxy resin (A-1) | Parts by mass | 100 | 100 | 100 | 100 | 100 | 100 | 100 | 100 | 100 | 100 |
| composition | Core-shell graft polymer (B1-1) | Parts by mass | 30 | 30 | 30 | 30 | 20 | 20 | 30 | 30 | 30 | 30 |
| | Blocked isocyanate (B2-1) | Parts by mass | — | — | — | — | 10 | 10 | — | — | — | — |
| | Carboxyl group-containing non -cross-linked | Parts by mass | — | — | — | — | 10 | 15 | — | — | — | |
| | acrylic (C-2) | | | | | | | | | | | |
| | Carboxyl group-containing non -cross-linked | Parts by mass | 15 | — | — | — | — | — | — | — | — | — |
| | acrylic (C-4) | | | | | | | | | | | |
| | Carboxyl group-containing non -cross-linked | Parts by mass | | 15 | 20 | — | — | — | — | — | — | — |
| | acrylic (C-5) | | | | | | | | | | | |
| | Carboxyl group-containing non -cross-linked | Parts by mass | — | — | — | 20 | — | — | — | — | — | — |
| | acrylic (C-6) | | | | | | | | | | | |
| | Non-cross-linked acrylic resin having no | Parts by mass | — | — | — | — | — | — | — | 10 | 7.5 | — |
| | carboxyl group (X-1) | | | | | | | | | | | |
| | Cross-linked acrylic resin (Y-1) | Parts by mass | — | — | — | — | — | — | — | — | — | 10 |
| | Epoxy curing agent (D-1) | Parts by mass | 7 | 7 | 7 | 7 | 7 | 7 | 7 | 7 | 7 | 7 |
| | Curing accelerator (E-1) | Part by mass | 1 | 1 | 1 | 1 | 1 | 1 | 1 | 1 | 1 | 1 |
| | Reactive diluent | Parts by mass | 10 | 10 | 10 | 10 | 10 | 10 | 10 | 10 | 10 | 10 |
| | Carbon black | Part by mass | 0.3 | 0.3 | 0.3 | 0.3 | 0.3 | 0.3 | 0.3 | 0.3 | 0.3 | 0.3 |
| | Heavy calcium carbonate | Parts by mass | 15 | 15 | 15 | 15 | 15 | 15 | 15 | 15 | 15 | 15 |
| | Calcium oxide | Parts by mass | 1.5 | 1.5 | 1.5 | 1.5 | 1.5 | 1.5 | 1.5 | 1.5 | 1.5 | 1.5 |
| Evaluation | Initial shear adhesive strength (F1) | MPa | 19.9 | 21.2 | 19.9 | 20.9 | 24.8 | 23.4 | 25 | 22.8 | 25.1 | 24.5 |
| | Post-moisture-absorption shear adhesive | MPa | 17.8 | 17.2 | 16.4 | 15.6 | 21.3 | 22.4 | 7.5 | 9.9 | 9.6 | 10.7 |
| | strength (F2) | | | | | | | | | | | |
| | Shear adhesive strength ratio (F2/F1) | | 0.89 | 0.81 | 0.83 | 0.74 | 0.86 | 0.96 | 0.30 | 0.43 | 0.38 | 0.44 |
| | Viscosity at 50° C. (η50) | Pa · s | 16 | 40 | 31 | 35 | 10 | 12 | 8 | 50 | 27 | 11 |
| | Viscosity at 100° C. (η100) | Pa · s | 174 | 93 | 179 | 92 | 40 | 108 | 1 | 30 | 18 | 24 |

| | | | | | | | | | | |
|---|---|---|---|---|---|---|---|---|---|---|
| Viscosity ratio (η100/η50) | 10.7 | 2.3 | 5.8 | 2.6 | 4.0 | 9.0 | 0.2 | 0.6 | 0.7 | 2.0 |

As is clear from the data shown in Table 1 and Table 2 above, the curable epoxy resin compositions of Examples 1 to 17 containing the epoxy resin (A), the toughening agent (B), and the carboxyl group-containing non-cross-linked acrylic resin (C) had favorable resistance to foaming by moisture absorption. Specifically, regarding the curable epoxy resin compositions of Examples 1 to 17, the values of the ratios (F2/F1) between shear adhesive strengths before and after moisture was absorbed were higher and the resistance to foaming by moisture absorption was favorable compared with the curable epoxy resin composition of Comparative Example 1 containing no carboxyl group-containing non-cross-linked acrylic resin (C), the curable epoxy resin compositions of Comparative Examples 2 and 3 containing the non-cross-linked acrylic resin having no carboxyl group, and the curable epoxy resin composition of Comparative Example 4 containing a cross-lined acrylic resin that is used as a conventional gelling agent.

Moreover, regarding the curable epoxy resin compositions of Examples 1 to 17, the values of the ratios (η100/η50) between viscosities before and after the temperature was increased and the values of the ratios (F2/F1) between shear adhesive strengths before and after moisture was absorbed were higher than those of the curable epoxy resin compositions of Comparative Examples 1 to 4, and therefore, it is presumed that the viscosity is significantly increased at a temperature of 100° C. or higher, and thus favorable resistance to foaming by moisture absorption is obtained.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A curable epoxy resin composition comprising:
an epoxy resin (A);
a toughening agent (B); and
a carboxyl group-containing non-cross-linked acrylic resin (C),
wherein the epoxy resin (A) includes one or more selected from the group consisting of a bisphenol A-type epoxy resin and a bisphenol F-type epoxy resin that have an epoxy equivalent of less than 220 g/eq.

2. The curable epoxy resin composition according to claim 1, wherein:
a ratio (F2/F1) between an initial lap shear strength (F1) and a post-moisture absorption shear adhesion strength (F2) is 0.5 or more,
the initial lap shear strength (F1) measured in accordance with JIS K 6850 before the curable epoxy resin composition is left to stand in an environment of saturated water vapor at 40° C., and
the post-moisture absorption shear adhesion strength (F2) measured in accordance with JIS K 6850 after the curable epoxy resin composition is left to stand for 3 days in the environment of the saturated water vapor at 40° C. is 0.5 or more.

3. The curable epoxy resin composition according to claim 1, wherein a ratio (η100/η50) between a viscosity value (η50) of the curable epoxy resin composition at a shear speed of 5 s⁻¹ and 50° C. and a viscosity value (η100) of the curable epoxy resin composition at a shear speed of 5 s⁻¹ and 100° C. is 2.3 or more.

4. The curable epoxy resin composition according to claim 1, wherein the toughening agent (B) is one or more selected from the group consisting of a polymer having a core-shell structure (B1), blocked isocyanate (B2), a rubber-modified epoxy resin (B3), a urethane-modified epoxy resin (B4), and a dimer acid-modified epoxy resin (B5).

5. The curable epoxy resin composition according to claim 1, wherein the carboxyl group-containing non-cross-linked acrylic resin (C) has a weight average molecular weight of 50,000 or more and 10,000,000 or less.

6. The curable epoxy resin composition according to claim 1, wherein the carboxyl group-containing non-cross-linked acrylic resin (C) has a glass-transition temperature of 50° C. or higher and 150° C. or lower.

7. The curable epoxy resin composition according to claim 1, wherein the carboxyl group-containing non-cross-linked acrylic resin (C) comprises methyl ethyl ketone soluble matter in an amount of 30 mass % or more and 100 mass % or less.

8. The curable epoxy resin composition according to claim 1, wherein the carboxyl group-containing non-cross-linked acrylic resin (C) is a copolymer obtained by copolymerizing monomer components including a carboxyl group and monomer components other than the monomer components including the carboxyl group.

9. The curable epoxy resin composition according to claim 1, wherein the carboxyl group-containing non-cross-linked acrylic resin (C) contains a carboxyl group in an amount of 0.05 mmol/g or more and 5.0 mmol/g or less.

10. The curable epoxy resin composition according to claim 1, comprising the toughening agent (B) in an amount of 1 part by mass or more and 100 parts by mass or less, and the carboxyl group-containing non-cross-linked acrylic resin (C) in an amount of 2.5 parts by mass or more and 100 parts by mass or less, relative to 100 parts by mass of the epoxy resin (A).

11. The curable epoxy resin composition according to claim 1, further comprising an epoxy curing agent (D) in an amount of 1 part by mass or more and 80 parts by mass or less relative to 100 parts by mass of the epoxy resin (A).

12. The curable epoxy resin composition according to claim 1, further comprising a curing accelerator (E) in an amount of 0.1 part by mass or more and 10 parts by mass or less relative to 100 parts by mass of the epoxy resin (A).

13. The curable epoxy resin composition according to claim 1, wherein the curable epoxy resin composition is a one-component curable epoxy resin composition.

14. A laminate comprising a plurality of substrates joined by a cured product of the curable epoxy resin composition according to claim 1.

15. The curable epoxy resin composition according to claim 6, wherein the carboxyl group-containing non-cross-linked acrylic resin (C) has a glass-transition temperature of 102° C. or higher and 150° C. or lower.

16. The curable epoxy resin composition according to claim 10, comprising the toughening agent (B) in an amount of 1 part by mass or more and 50 parts by mass or less.

17. A laminate comprising a plurality of substrates joined by a cured product of the curable epoxy resin composition according to claim 2.
